(19) United States
(12) Patent Application Publication
(10) Pub. No.: US 2025/0058477 A1
(43) Pub. Date: Feb. 20, 2025

(54) SENSOR DEVICE AND ROBOT

(71) Applicant: SONY GROUP CORPORATION, TOKYO (JP)

(72) Inventor: TETSUYA NARITA, TOKYO (JP)

(21) Appl. No.: 18/721,397

(22) PCT Filed: Nov. 2, 2022
(86) PCT No.: PCT/JP2022/040997

§ 371 Date: Jun. 18, 2024

(30) Foreign Application Priority Data
Dec. 28, 2021 (JP) 2021-214428

(51) Int. Cl. B25J 13/08; B25J 15/00; B25J 19/02

(52) U.S. Cl. CPC B25J 13/084; B25J 13/083; B25J 13/089; B25J 15/0009; B25J 15/0014; B25J 19/02

(57) ABSTRACT

A sensor device according to the present disclosure includes: a flexible layer having at least one hole; and a sensor structure attached with the flexible layer, the sensor structure including an imaging device, the imaging device being configured to observe the flexible layer and observe an object in an outside world through the hole of the flexible layer.

### TECHNICAL FIELD

The present disclosure relates to a sensor device and a robot.

### BACKGROUND ART

An existing sensor device is allowed to perform so-called multimodal sensing and the multimodal sensing allows for acquiring a plurality of pieces of physical information (modals) as sensor information (for example, see PTLs 1 and 2).

### CITATION LIST

### Patent Literature

PTL 1: International Publication No. WO 2009/144767

PTL 2: Japanese Unexamined Patent Application Publication No. 2018-9792

### SUMMARY OF THE INVENTION

It is desired to perform a highly accurate multimodal sensing.

It is desirable to provide a sensor device and a robot allowed to perform a highly accurate multimodal sensing.

A sensor device according to an embodiment of the present disclosure includes: a flexible layer having at least one hole; and a sensor structure attached with the flexible layer, the sensor structure including an imaging device, the imaging device being configured to observe the flexible layer and observe an object in an outside world through the hole of the flexible layer.

A robot according to an embodiment of the present disclosure includes: a sensor device; and a control device that performs a robot control based on sensor information from the sensor device, in which the sensor device includes: a flexible layer having at least one hole; and a sensor structure attached with the flexible layer, the sensor structure including an imaging device, the imaging device being configured to observe the flexible layer and observe an object in an outside world through the hole of the flexible layer.

The sensor device or the robot according to the embodiment of the present disclosure allows for observation of the flexible layer attached to the sensor structure and observation of an object in the outside world through the hole of the flexible layer by virtue of the imaging device installed in the sensor structure.

### BRIEF DESCRIPTION OF DRAWING

FIG. 1 is a diagram of assistance in explanation, illustrating an overview of a sensor device according to an embodiment of the present disclosure.

FIG. 2 includes an appearance view and a top view of a schematic configuration example of a gel serving as a flexible layer in the sensor device according to the embodiment.

FIG. 3 is a diagram of assistance in explanation, illustrating an overview of measures of controlling a robot with use of the sensor device according to the embodiment.

FIG. 4 is a top view of a schematic configuration example of the gel in the sensor device according to the embodiment.

FIG. 5 is a top view of a schematic configuration example of the gel in the sensor device according to the embodiment.

FIG. 6 is a top view of a schematic configuration example of the gel in the sensor device according to the embodiment.

FIG. 7 is an appearance view of a schematic configuration example of the gel in the sensor device according to the embodiment.

FIG. 8 is a diagram of assistance in explanation, schematically illustrating a difference in object recognition attributed to a difference in structure of the gel in the sensor device according to the embodiment.

FIG. 9 is a diagram of assistance in explanation, schematically illustrating an example of a method of improving an object recognition rate of the sensor device according to the embodiment.

FIG. 10 is a characteristic diagram illustrating an example of a relationship between a ratio of an area occupied by the gel in the sensor device according to the embodiment and the object recognition rate.

FIG. 11 is a diagram of assistance in explanation, diagrammatically illustrating a state of object recognition depending on the ratio of the area occupied by the gel in the sensor device according to the embodiment.

FIG. 12 is a characteristic diagram illustrating an example of a relationship between a transparency of the gel in the sensor device according to the embodiment and the object recognition rate.

FIG. 13 is a diagram of assistance in explanation, diagrammatically illustrating the state of object recognition depending on the transparency of the gel in the sensor device according to the embodiment.

FIG. 14 is a diagram of assistance in explanation, illustrating an example of a state where buckling of the gel occurs in the sensor device according to the embodiment.

FIG. 15 is an appearance view of a schematic configuration example of the sensor device according to the embodiment.

FIG. 16 is an appearance view of a schematic modification example of a configuration of the sensor device according to the embodiment.

FIG. 17 is an appearance view of a schematic modification example of a configuration of the gel in the sensor device according to the embodiment.

FIG. 18 is an appearance view of a schematic modification example of the configuration of the gel in the sensor device according to the embodiment.

FIG. 19 is an appearance view of a schematic modification example of the configuration of the gel in the sensor device according to the embodiment.

FIG. 20 is an appearance view of a schematic modification example of the configuration of the gel in the sensor device according to the embodiment.

FIG. 21 is an appearance view of a schematic configuration example where a colored part is provided in a front surface of the gel in the sensor device according to the embodiment.

FIG. 22 is a diagram of assistance in explanation, illustrating an example of an image of the gel observed in a case where the colored part is provided in the front surface of the gel in the sensor device according to the embodiment.

FIG. 23 is a cross-sectional view of a schematic modification example of the configuration of the gel in the sensor device according to the embodiment.

FIG. 24 is an appearance view of a schematic modification example of the configuration of the gel in the sensor device according to the embodiment.

FIG. 25 is a configuration diagram schematically illustrating a modification example of the configuration of the gel in the sensor device according to the embodiment.

FIG. 26 is an appearance view of a schematic modification example of the configuration of the gel in the sensor device according to the embodiment.

FIG. 27 is a configuration diagram schematically illustrating a modification example of the configuration of the sensor device according to the embodiment.

FIG. 28 is a configuration diagram schematically illustrating a modification example of the configuration of the sensor device according to the embodiment.

FIG. 29 is a diagram of assistance in explanation, schematically illustrating an example of a method of estimation of a distance by the sensor device according to the embodiment.

FIG. 30 is a configuration diagram schematically illustrating a modification example of the configuration of the sensor device according to the embodiment.

FIG. 31 is a configuration diagram schematically illustrating a modification example of the configuration of the sensor device according to the embodiment.

FIG. 32 is a configuration diagram schematically illustrating a modification example of the configuration of the sensor device according to the embodiment.

FIG. 33 is a configuration diagram schematically illustrating a modification example of the configuration of the sensor device according to the embodiment.

FIG. 34 is a configuration diagram schematically illustrating a modification example of the configuration of the sensor device according to the embodiment.

FIG. 35 is a diagram of assistance in explanation, schematically illustrating an example of measures of distance measurement by the sensor device according to the embodiment.

FIG. 36 is a diagram of assistance in explanation, schematically illustrating an example of a relationship between a reflected wave from the gel and a reflected wave from an object and the reflected waves are detected in a case where distance measurement is performed by the sensor device according to the embodiment.

FIG. 37 is a diagram of assistance in explanation, schematically illustrating an example of measures of separating the reflected wave from the gel from the reflected wave from the object in the sensor device according to the embodiment.

FIG. 38 is a diagram of assistance in explanation, schematically illustrating an example of the measures of separating the reflected wave from the gel from the reflected wave from the object in the sensor device according to the embodiment.

FIG. 39 is a diagram of assistance in explanation, schematically illustrating a modification example of the measures of distance measurement by the sensor device according to the embodiment.

FIG. 40 is a diagram of assistance in explanation, schematically illustrating a modification example of the measures of distance measurement by the sensor device according to the embodiment.

FIG. 41 is a diagram of assistance in explanation, schematically illustrating a modification example of the measures of distance measurement by the sensor device according to the embodiment.

FIG. 42 is a diagram of assistance in explanation, schematically illustrating a modification example of the measures of distance measurement by the sensor device according to the embodiment.

FIG. 43 is a diagram of assistance in explanation, schematically illustrating a modification example of the measures of distance measurement by the sensor device according to the embodiment.

FIG. 44 is a diagram of assistance in explanation, schematically illustrating an example of measures of detection of a contact position by the sensor device according to the embodiment.

FIG. 45 is a diagram of assistance in explanation of an initial slip.

FIG. 46 is a diagram of assistance in explanation, schematically illustrating an example of a slip phenomenon that occurs in the gel in the sensor device according to the embodiment.

FIG. 47 is a diagram of assistance in explanation, schematically illustrating an example of measures of detection of an initial slip by the sensor device according to the embodiment.

FIG. 48 is a diagram of assistance in explanation, illustrating an example of an image of the gel observed in a case where the colored part is provided in the front surface of the gel in the sensor device according to the embodiment.

FIG. 49 is a diagram of assistance in explanation, illustrating an example of an image of the gel observed in a case where the colored part is provided in the front surface of the gel in the sensor device according to the embodiment.

FIG. 50 is a diagram of assistance in explanation, illustrating an example of an image of the gel observed in a case where the colored part is provided in the front surface of the gel in the sensor device according to the embodiment.

FIG. 51 is a diagram of assistance in explanation, schematically illustrating an example of measures of texture detection and detection of a whole slip by the sensor device according to the embodiment.

FIG. 52 is a diagram of assistance in explanation, illustrating a first example of a method of estimation of a contact force by the sensor device according to the embodiment.

FIG. 53 is a diagram of assistance in explanation, illustrating a second example of the method of estimation of a contact force by the sensor device according to the embodiment.

FIG. 54 is a diagram of assistance in explanation, illustrating a third example of the method of estimation of a contact force by the sensor device according to the embodiment.

FIG. 55 is a diagram of assistance in explanation, illustrating an example of a modal of the sensor device and the modal are to be used with the execution of a task by a robot according to the embodiment.

FIG. 56 is a diagram of assistance in explanation, illustrating the example of a modal of the sensor device and the modal are to be used with the execution of the task by the robot according to the embodiment.

FIG. 57 is a diagram of assistance in explanation, illustrating an example of pairing of a modal of the sensor device according to the embodiment with a control law of the robot.

FIG. 58 is a flowchart illustrating an execution example of an object holding task by the robot according to the embodiment.

FIG. 59 is a flowchart illustrating an execution example of a button pressing task by the robot according to the embodiment.

FIG. 60 is a flowchart illustrating an execution example of an object holding task (with failure recovery) by the robot according to the embodiment.

FIG. 61 is a flowchart illustrating an execution example of a task of causing the robot according to the embodiment to stick a tape by pressing it from above.

FIG. 62 is a diagram of assistance in explanation, illustrating an example of how to determine termination conditions and branch conditions for skills in causing the robot according to the embodiment to execute a task.

FIG. 63 is a diagram of assistance in explanation, illustrating an example of the setting of the priorities of the skills in causing the robot according to the embodiment to execute a task.

FIG. 64 is a diagram of assistance in explanation, illustrating an example of how to determine the setting of the priorities of the skills in causing the robot according to the embodiment to execute a task.

FIG. 65 is a diagram of assistance in explanation, illustrating an example of the pairing of a modal of the sensor device according to the embodiment with a control law of the robot.

FIG. 66 is a diagram of assistance in explanation, illustrating an example where a control value of the robot is to be outputted without paring a modal of the sensor device according to the embodiment with a control law of the robot.

FIG. 67 is a block diagram illustrating a configuration example of a control device of the robot according to the embodiment.

FIG. 68 is a block diagram illustrating a configuration example of a contact position detector in the control device of the robot according to the embodiment.

FIG. 69 is a block diagram illustrating a configuration example of an initial slip detector in the control device of the robot according to the embodiment.

### MODES FOR CARRYING OUT THE INVENTION

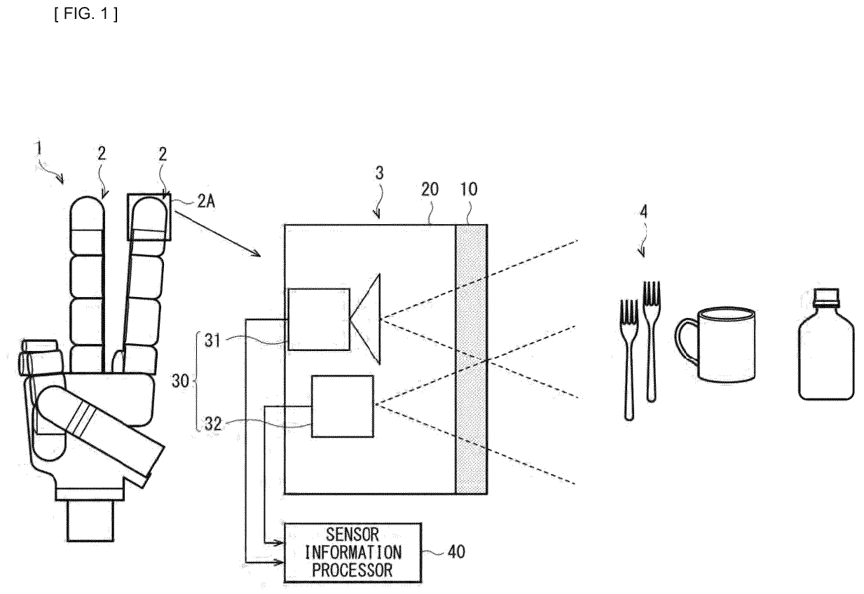

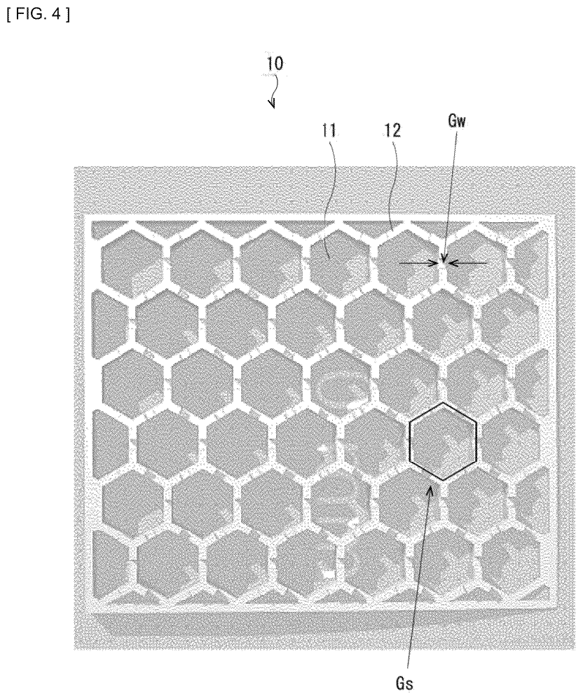

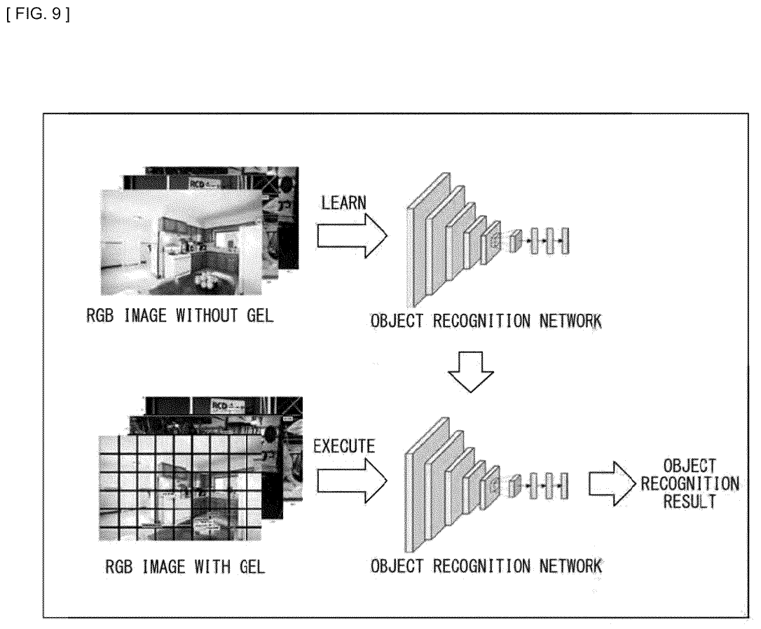

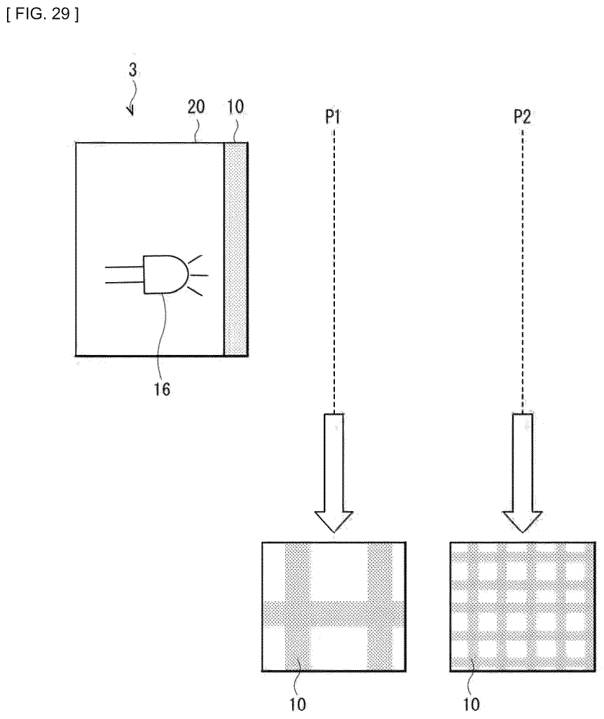

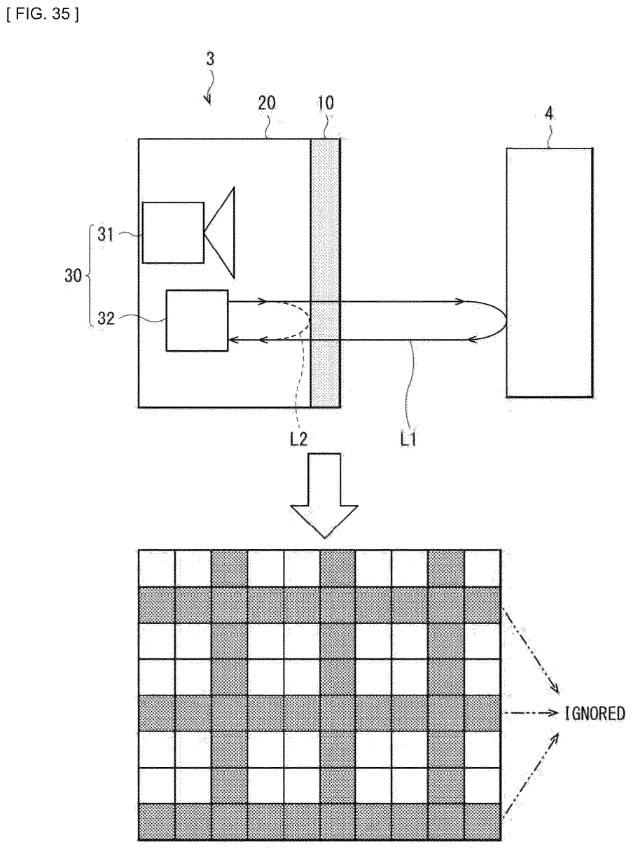

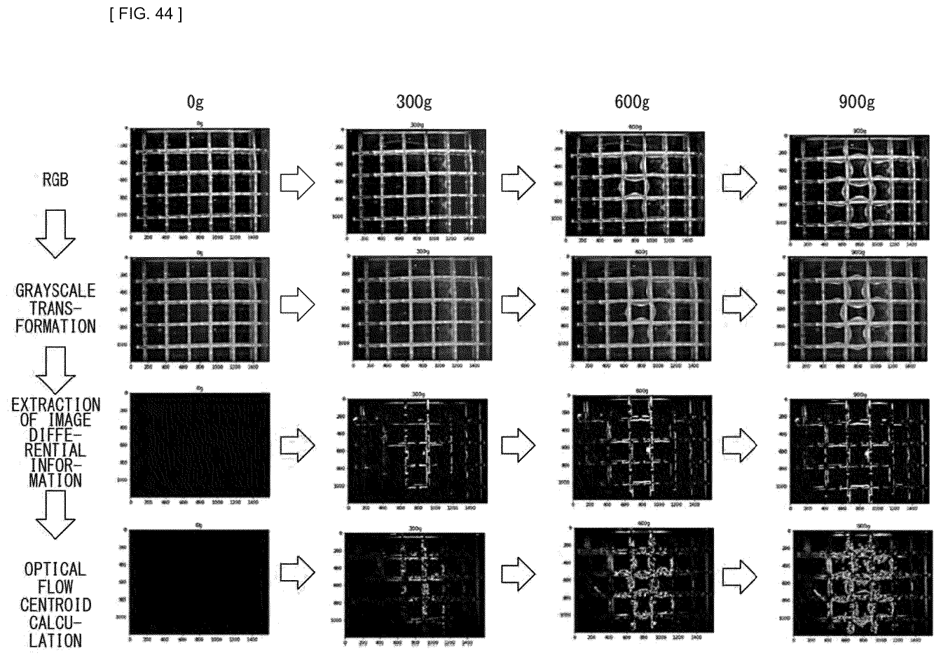

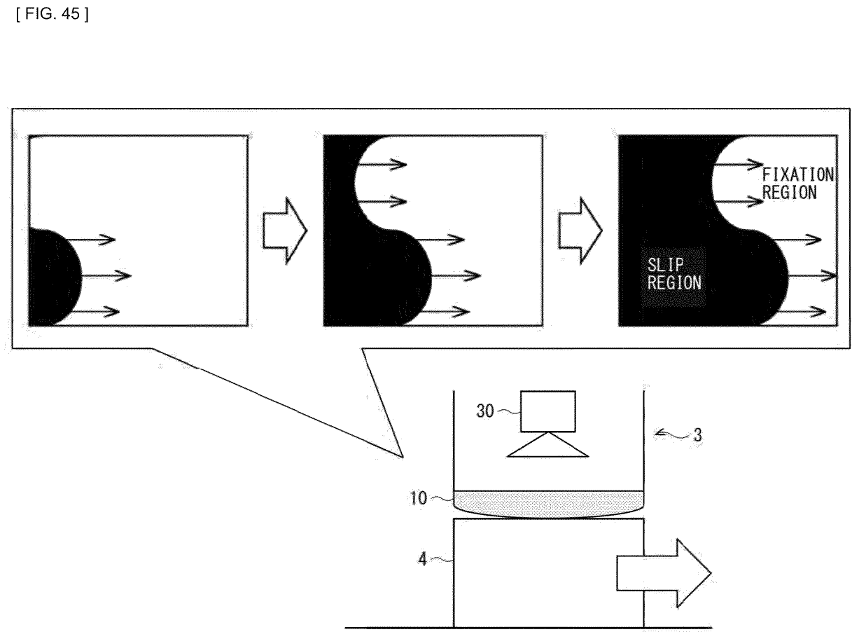

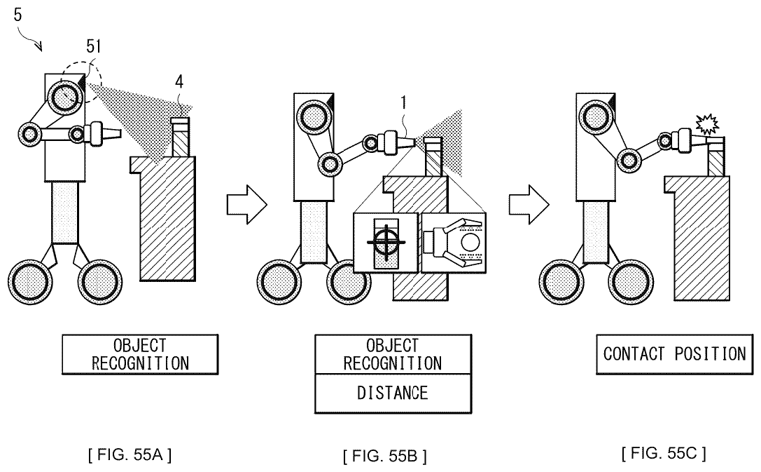

In the following, some embodiments of the present disclosure are described in detail with reference to the drawings. It is to be noted that description is made in the following order.
1. Embodiment
1.0 Overview of Sensor Device and Robot According to Embodiment (FIG. 1 to FIG. 3)
1.1 Configuration of Flexible layer (Gel) (FIG. 4 to FIG. 28)
1.2 Sensing (FIG. 29 to FIG. 34)
1.3 Object Recognition (FIG. 9)
1.4 Distance Measurement (FIG. 35 to FIG. 43)
1.5 Tactile Sense (FIG. 44 to FIG. 54)
1.6 Control of Robot (FIG. 55 to FIG. 69)
1.7 Effects
2. Other Embodiments

### 1. Embodiment

### 1.0 Overview of Sensor Device and Robot According to Embodiment

For a stable manipulation task, it is effective to use a fingertip sensor allowed to perform so-called multimodal sensing (having a plurality of senses). The multimodal sensing allows for acquiring a plurality of pieces of physical information (modals) as sensor information. Examples include a tactile sense (for example, slip detection, material recognition, and contact recognition) and a proximity sense (for example, Depth (distance) recognition and object recognition). However, it is difficult to develop a sensor allowed to acquire desired all tactile information and proximity information.

The fingertip sensor is allowed to acquire tactile information by, for example, observing the deformation of a contact surface of a fingertip. Proximity information is acquirable by, for example, observing an environment of the outside world. However, it is difficult to develop an effective means of simultaneously observing both the deformation of the contact surface and the environment of the outside world.

Meanwhile, a proposed sensor device is allowed to not only observe the outside world through a transparent flexible layer (gel) with no hole but also observe the deformation of the gel at the same time. However, in a case where the transparent gel with no hole is used, the dirtiness or wear of the gel makes it difficult to observe the outside world. In addition, in a case where the transparent gel with no hole is used, it is unlikely to detect the deformation of the gel in a normal direction of a contact surface with an object that is an observation target and thus it is difficult to detect contact with the object with a good sensitivity.

Accordingly, for a sensor device according to the embodiment, a technique enabling multimodal sensing to be performed with use of a compliant gel with a hole is proposed. The sensor device according to the embodiment allows for observing the outside of a contact surface through the hole made in the compliant gel. In addition, the formation of the hole in the gel facilitates the deformation of the gel, which makes it possible to detect contact with a good sensitivity.

The sensor device according to the embodiment is usable in robots in a variety of forms that are likely to come into contact with an environment, such as a manipulation robot, a legged robot, and a drone. Description will be made below by taking for example a manipulation robot having a finger serving as a manipulator.

For a manipulation robot, it is important to feed back multimodal sensor information in order to stably execute a task that necessitates contact. For the manipulation robot, a necessary modal varies depending on task. For example, necessary modals for a task involving a pressing action and a task involving a holding action are different. It is demanded to perform a manipulation action while selecting an appropriate modal in accordance with a task. However, it is not realistic to replace a finger serving as a manipulator for each task. Thus, a multimodal sensor device allowed to measure a variety of physical quantities is demanded as a fingertip sensor. In particular, a proximity sense and a tactile sense are absolutely essential for manipulation. Accordingly, it is desired to develop a sensor device allowed to simultaneously acquire both proximity sense and tactile sense.

In a case where the outside world is observed through a transparent gel and, simultaneously, the deformation of the gel is observed, there are two concerns. First, a contact strength is unlikely to be detected due to a poor sensitivity in a normal direction. Secondly, breakage of a front surface due to repeated use results in a difficulty in object detection. Accordingly, an improvement in the sensitivity in the normal direction and a structure allowing for object detection irrespective of breakage of the front surface are demanded.

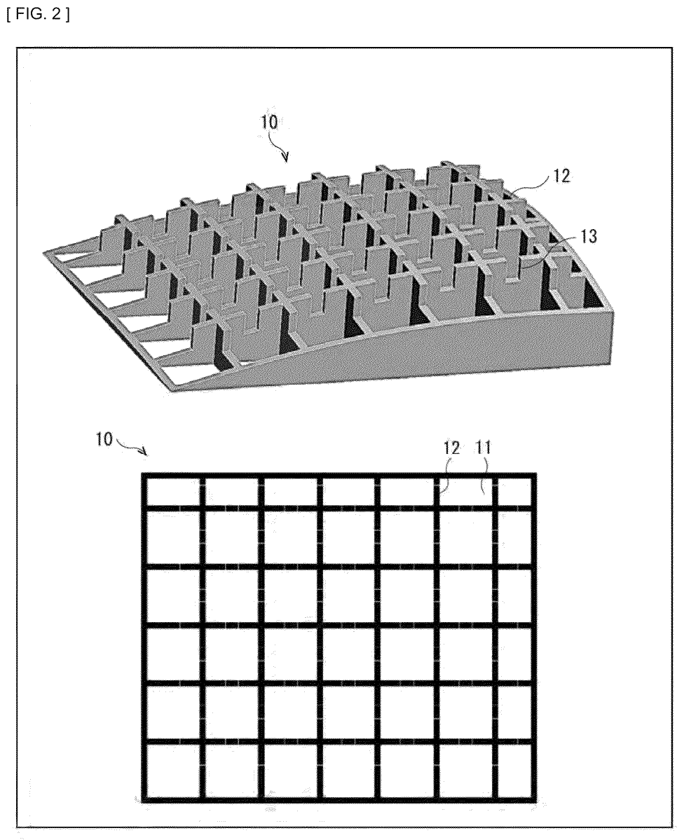

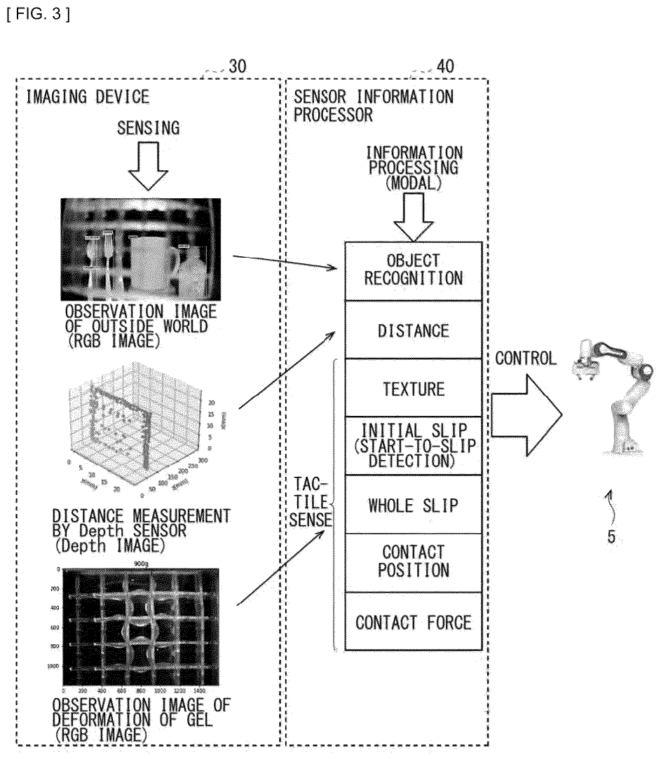

FIG. 1 illustrates an overview of a sensor device 3 according to the embodiment of the present disclosure. FIG. 2 includes an appearance view (an upper tier in FIG. 2) and a top view (a lower tier in FIG. 2) of a schematic configuration example of a gel 10 serving as a flexible layer in the sensor device 3. FIG. 3 illustrates an overview of measures of controlling a robot 5 with use of the sensor device 3.

The sensor device 3 according to the embodiment is usable in the robot 5 having, for example, a hand 1. The hand 1 has a finger 2 serving as a manipulator. The sensor device 3 is provided in, for example, the finger 2. The robot 5 includes a control device that performs a robot control based on sensor information from the sensor device 3.

The sensor device 3 includes the gel 10 serving as the flexible layer, a sensor structure 20 attached with the gel 10, and a sensor information processor 40.

The gel 10 includes a transparent compliant material. At least one hole 11 is made in the gel 10. The gel 10 may have a meshed structure having a plurality of holes 11. The gel 10 may have, for example, a grid structure or a honeycomb structure having the plurality of holes 11. The plurality of holes 11 may be made at regular intervals. FIG. 2 illustrates a configuration example where the gel 10 has a grid structure having a lattice-shaped partition 12. The partition 12 on a front surface of the gel 10 may be partially provided with a slit 13. The gel 10 and the sensor structure 20 may form a whole or a part of the manipulator of the robot 5 as a whole.

An imaging device 30 is installed in the sensor structure 20. The imaging device 30 allows for observation of the gel 10 and observation of an object 4 in the outside world through the hole 11.

The sensor device 3 has a function as a tactile sensor that acquires tactile information on the basis of deformation information regarding the gel 10 observed via the imaging device 30 and a function as a proximity sensor that acquires proximity information on the basis of observation information regarding the object 4 observed through the hole 11 of the gel 10.

The sensor information processor 40 includes an information processor that acquires, as information regarding a plurality of modals, the tactile information and the proximity information on the basis of the sensor information from the imaging device 30.

The sensor information processor 40 may acquire, as the proximity information, information (modal) including at least one of information regarding object recognition or information regarding a distance to the object 4 as illustrated in FIG. 3. In addition, sensor information processor 40 may acquire, as the tactile information, information (modal) including texture information regarding the object 4, information regarding an initial slip and a whole slip of the gel 10 relative to the object 4, and at least one of information regarding a contact position with the object 4 or information regarding a contact force relative to the object 4. The control device of the robot 5 performs the robot control on the basis of the proximity information and the tactile information acquired by the sensor information processor 40.

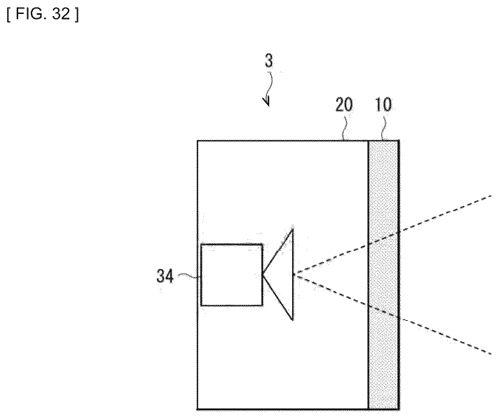

The imaging device 30 may include at least one color image sensor 31 allowed to acquire color images serving as an observation image of the outside world and an observation image of the deformation (a deformation image) of the gel 10. For example, an RGB camera allowed to acquire an RGB image may be included as the color image sensor 31. In addition, at least one distance sensor 32 allowed to acquire distance information may be included as the imaging device 30. For example, a Depth sensor allowed to acquire a Depth image may be included as the distance sensor 32. In addition, at least one color image sensor 31 allowed to acquire a color image and distance information may be included as the imaging device 30. For example, an RGB-D camera 34 (FIG. 32 as mentioned later) may be included as the color image sensor 31.

### 1.1 Configuration of Flexible layer (Gel)

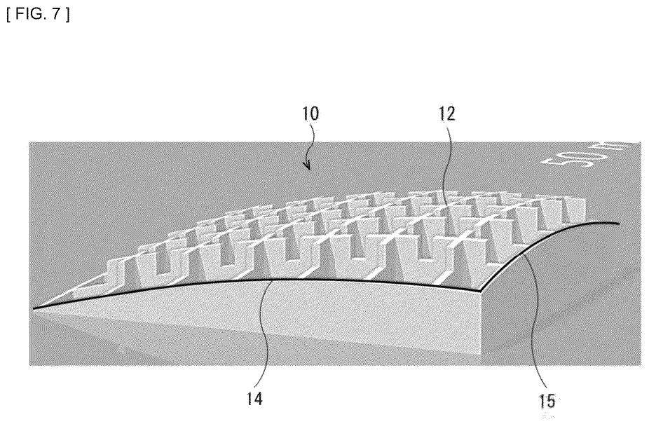

FIG. 4 to FIG. 6 are top views of schematic configuration examples of the gel 10 in the sensor device 3. FIG. 7 is an appearance view of a schematic configuration example of the gel 10 in the sensor device 3.

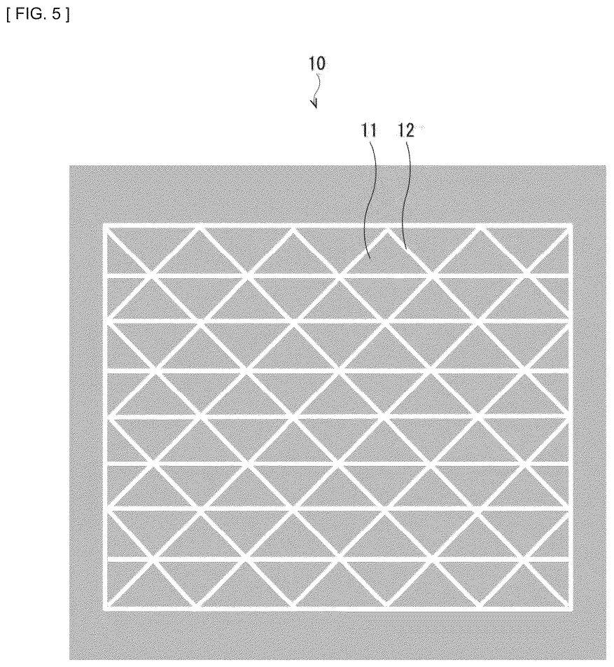

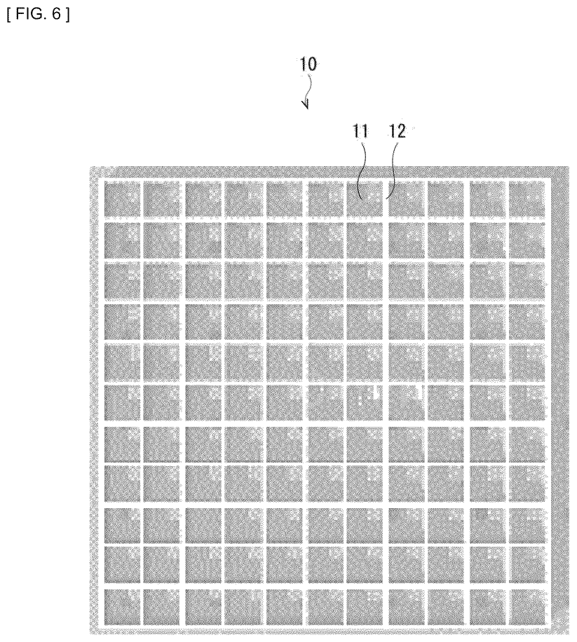

The mesh structure of the gel 10 may include a honeycomb structure having the hole 11 in a hexagonal shape as illustrated in FIG. 4. In addition, the mesh structure of the gel 10 may include a structure having the hole 11 in a triangular shape as illustrated in FIG. 5. In addition, the mesh structure of the gel 10 may include a grid structure having the hole 11 in a quadrangular (rectangular) shape as illustrated in FIG. 6.

In the gel 10, a width Gw of the gel 10 (a width of the partition 12) and a size Gs of the hole 11 serve as parameters that affect a recognition rate of the object 4. A gel occupancy rate (a ratio of occupancy of the region other than the hole 11) affects the recognition rate of the object 4 as described later. The width Gw of the gel 10 and the size Gs of the hole 11 may be determined in accordance with a desired performance for object recognition.

In addition, in the gel 10, the shape of the hole 11 serves as a parameter that determines the deformability of the gel 10. The shape of the hole 11 may be determined in accordance with a desired detection performance for the contact position or a slip detection performance. For example, the hole 11 in a hexagonal shape (the honeycomb structure) lowers the deformability, which reduces the detection performance for the contact position or the slip detection performance as compared with in a case where the hole 11 is in a quadrangular (rectangular) shape.

In addition, the front surface of the gel 10 in the form of a curved surface makes it possible to stably detect slip. As illustrated in FIG. 7, envelope surfaces 14 and 15 of the gel 10 are designed to be curved surfaces, which makes a slip likely to be detected. It is possible to change the setting of a curvature radius of the front surface of the gel 10 in accordance with the object 4, a task, or a position where the sensor device 3 is attached in the finger 2. For example, an increase in the curvature radius (causing the curved surfaces to be gentle) is suitable for a case where the larger object 4 or the slippery object 4 requiring a contact area is to be held. An increase in the curvature radius is suitable for a task for which the stability, not the accuracy, of an action is more important. In contrast, a reduction in the curvature radius (causing the curved surfaces to be steep is suitable for a case where the small object 4 is to be held or an action such as pinching is to be performed. A reduction in the curvature radius is suitable for a task for which an accuracy, not stability, of an action is more important.

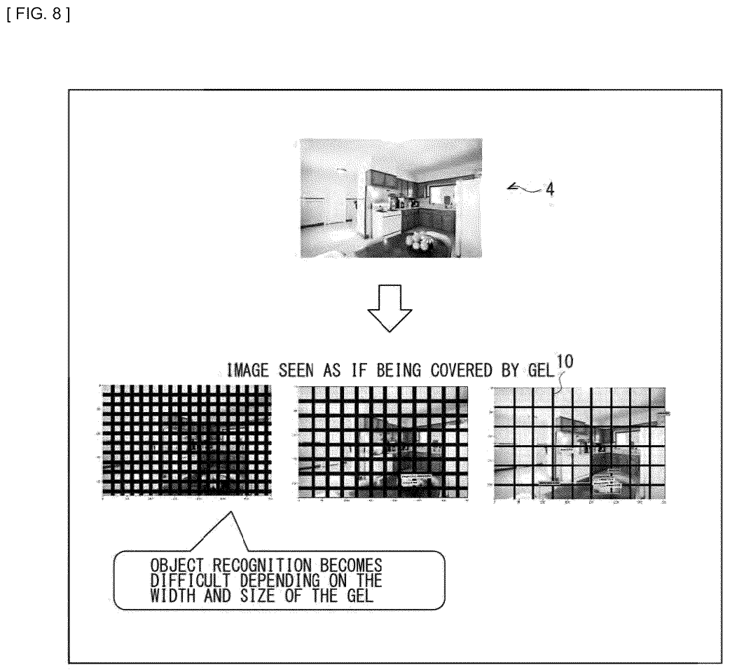

FIG. 8 schematically illustrates a difference in object recognition attributed to a difference in the structure of the gel 10 in the sensor device 3. A lower tier in FIG. 8 illustrates an image seen as if being covered by the gel 10.

In the sensor device 3, the width Gw of the gel 10 and the size Gs of the hole 11 affect the object recognition rate. As illustrated in FIG. 8, object recognition becomes difficult depending on the width Gw of the gel 10 and the size Gs. For example, a reduction in size of the hole 11 and an increase in the width Gw of the gel 10 make object recognition difficult.

FIG. 9 schematically illustrates an example of a method of improving the object recognition rate of the sensor device 3.

Ideally, the sensor device 3 first learns, for example, an RGB image in a state with no gel 10 through an object recognition network as illustrated in FIG. 9. Then, while a learning result through the object recognition network in the state with no gel 10 is taken into account, an RGB image obtained in a state with the gel 10 is learnt through the object recognition network. This facilitates the learning.

### Evaluation of Ratio of Area Occupied by Gel 10

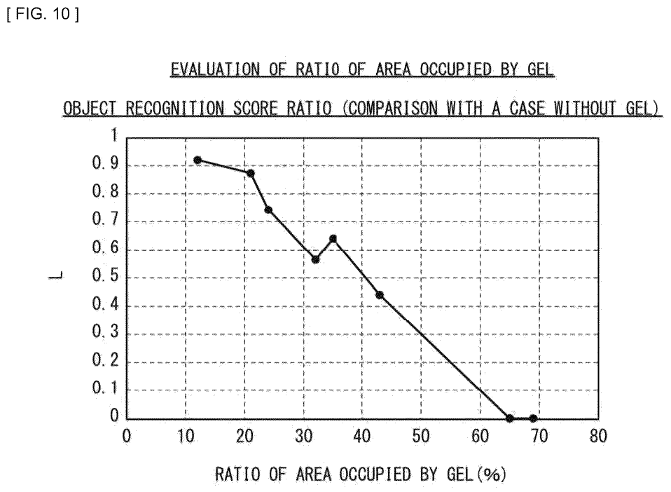

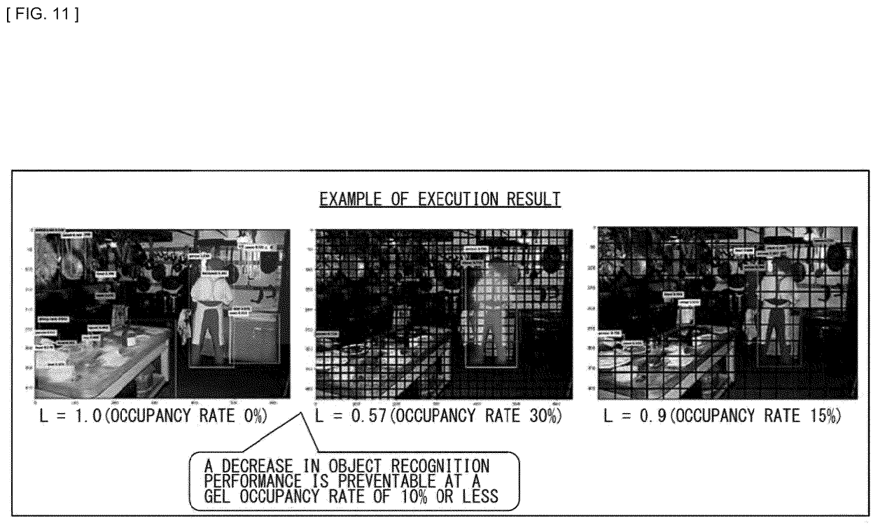

FIG. 10 illustrates an example of a relationship between the ratio of an area occupied by the gel 10 and the object recognition rate in the sensor device 3. FIG. 11 diagrammatically illustrates a state of object recognition depending on the ratio of the area occupied by the gel 10 in the sensor device 3.

In the sensor device 3, the width Gw of the gel 10 and the size Gs of the hole 11 affect the object recognition rate. In FIG. 10, the horizontal axis represents the ratio (%) of the area occupied by the gel (the gel occupancy rate) and the vertical axis represents an object recognition score ratio L as compared with in a case where no gel 10 is present. In addition, FIG. 11 diagrammatically illustrates respective states of object recognition at gel occupancy rates of 0%, 300%, and 15%. As is understood from results in FIG. 10 and FIG. 11, it is possible to prevent a decrease in object recognition performance of the sensor device 3 by causing the gel occupancy rate (the ratio of occupancy of the region other than the hole 11) to be 10% or less.

### Evaluation of Transparency of Gel 10

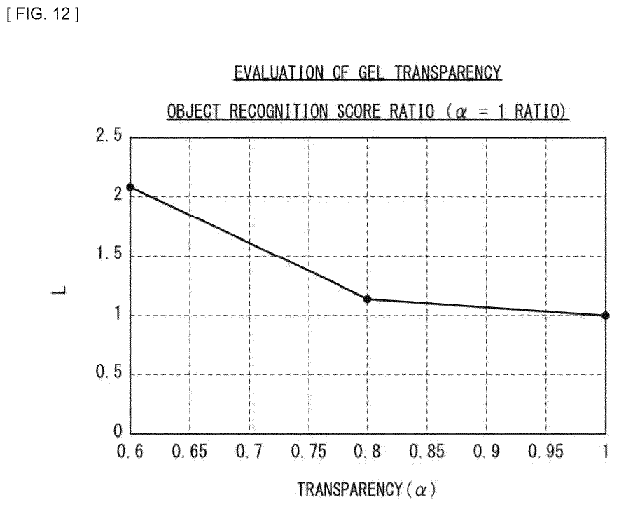

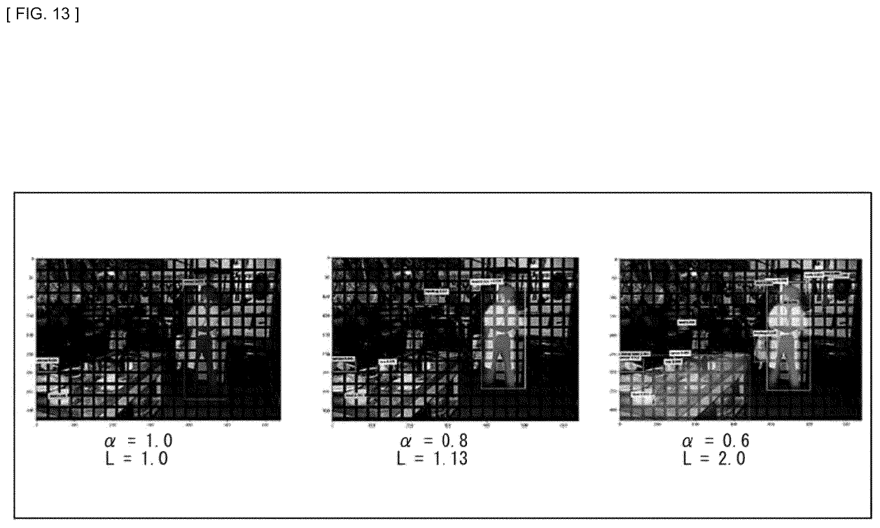

FIG. 12 illustrates an example of a relationship between a transparency of the gel 10 and the object recognition rate in the sensor device 3. FIG. 13 diagrammatically illustrates the state of object recognition depending on the transparency of the gel 10 in the sensor device 3.

In FIG. 12, the horizontal axis the represents transparency (α) and the vertical axis represents the object recognition score ratio L as compared with in a case where α=1. A smaller value of a indicates a higher transparency. In addition, FIG. 13 diagrammatically illustrates respective states of object recognition at the transparency α=1.0, 0.8, and 0.6. As is understood from results in FIG. 12 and FIG. 13, the object recognition performance is improved by virtue of the gel 10 including a transparent material.

### Relationship Between Shape of Hole 11 of Gel 10 and Deformability

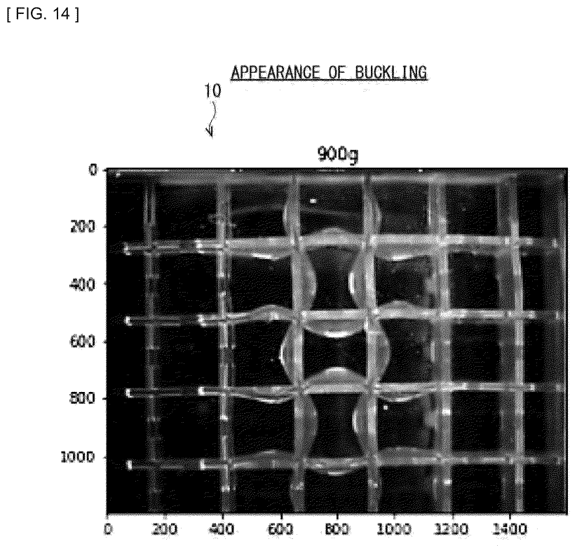

FIG. 14 illustrates an example of a state where buckling of the gel 10 occurs in the sensor device 3. FIG. 14 illustrates the example where buckling occurs in a case where a load of 900 g is applied.

In the sensor device 3, the shape of the hole 11 determines the deformability of the gel 10. The gel 10 is caused to have the grid structure (a lattice-shaped structure) as illustrated in FIG. 2, which makes buckling of the gel 10 likely to occur. The buckling of the gel 10 makes it possible to covert a force in the normal direction to a change in a tangential direction. This allows for raising a sensitivity relative to contact. In addition, buckling is facilitated by making the slit 13 (FIG. 2) in the front surface of the gel 10.

In the sensor device 3, different structures may be applied to the gel 10 in accordance with the magnitude of an assumable application load. For example, a grid structure (see, for example, FIG. 2) in which the hole 11 of the gel 10 has a rectangular shape may be applied for a low load and a honeycomb structure (see, for example, FIG. 4) in which the hole 11 of the gel 10 has a hexagonal shape may be applied for a high load.

### Curvature of Front Surface of Gel 10

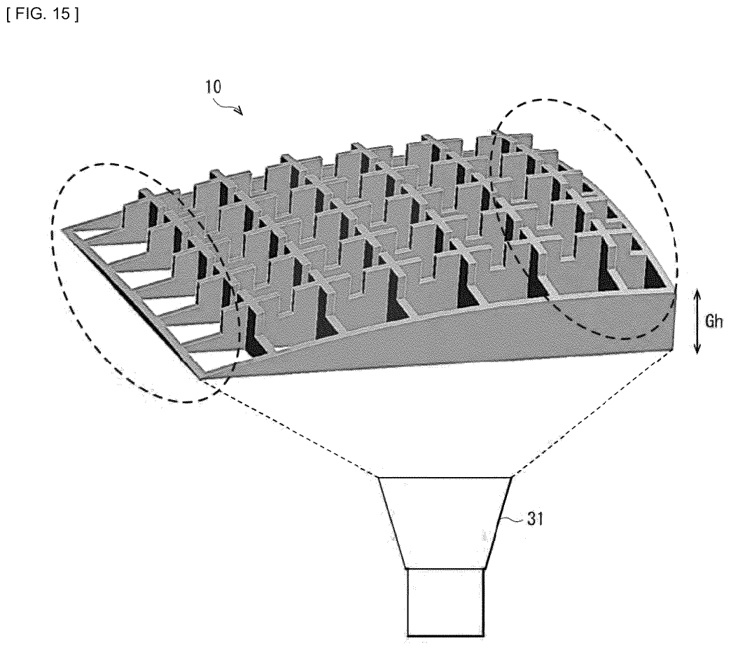

FIG. 15 schematically illustrates a configuration example of the sensor device 3.

For example, a height Gh of the gel 10 is subject to a limitation depending on an angle of view of the color image sensor 31. In particular, unless the height Gh of the gel 10 is reduced at an end portion, the field of vision is blocked, which makes it difficult to observe the outside world. The curvature radius of the front surface of the gel 10 (the envelope surfaces 14 and 15, see FIG. 7) may be determined in view of this restriction.

### Modification Examples of Configuration of Sensor Device 3

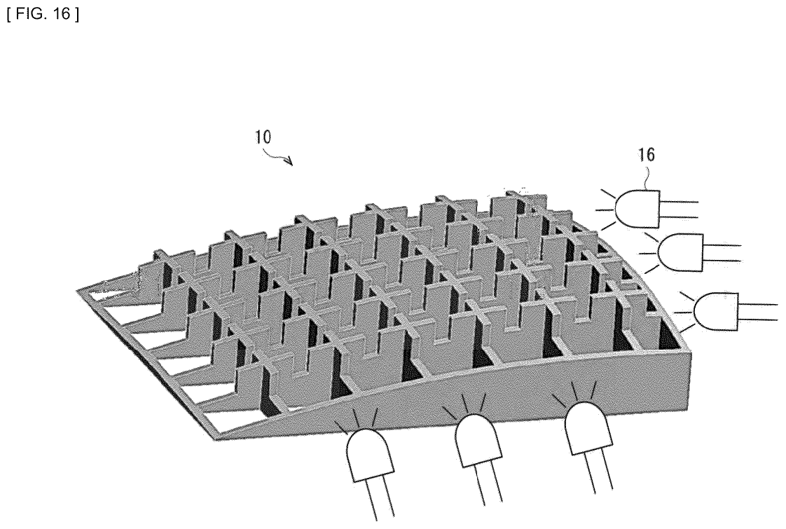

FIG. 16 schematically illustrates a modification example of the configuration of the sensor device 3.

In order to favorably observe the deformation of the gel 10 through the color image sensor 31, an illumination light source 16 such as an LED (Light Emitting Diode) may be attached to the sensor device 3. As for a position of the illumination light source 16, light may be applied from the side of the gel 10 or may be applied from an imaging device 30 side (a rear surface side of the gel 10). A plurality of illumination light sources 16 may be provided.

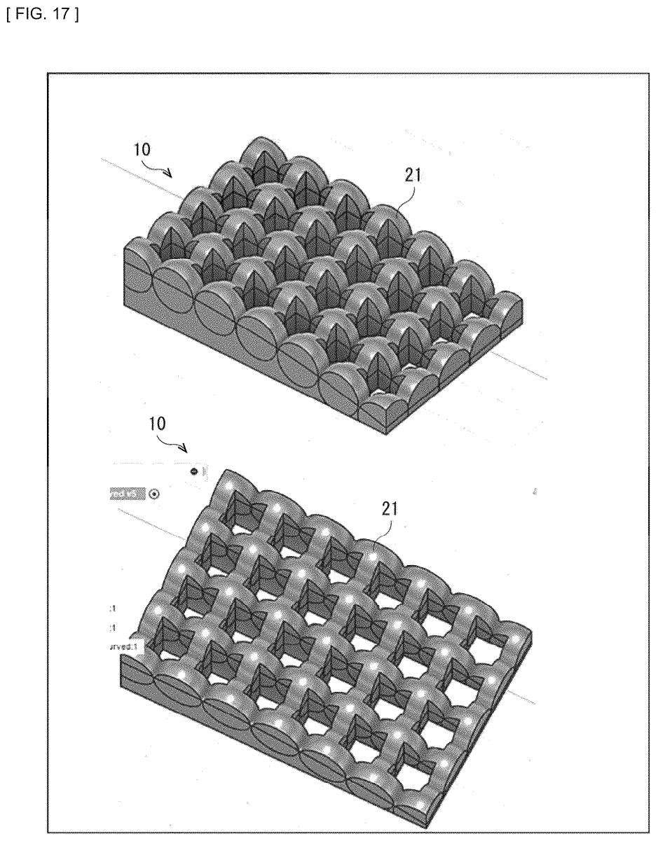

FIG. 17 to FIG. 20 schematically illustrate modification examples of the configuration of the gel 10 in the sensor device 3.

As illustrated in FIG. 17, individual projections and recesses of the front surface of the gel 10 are in the form of a curved surface 21, which facilitates detection of an initial slip. An initial slip is a phenomenon where only a portion of a contact region starts to slip.

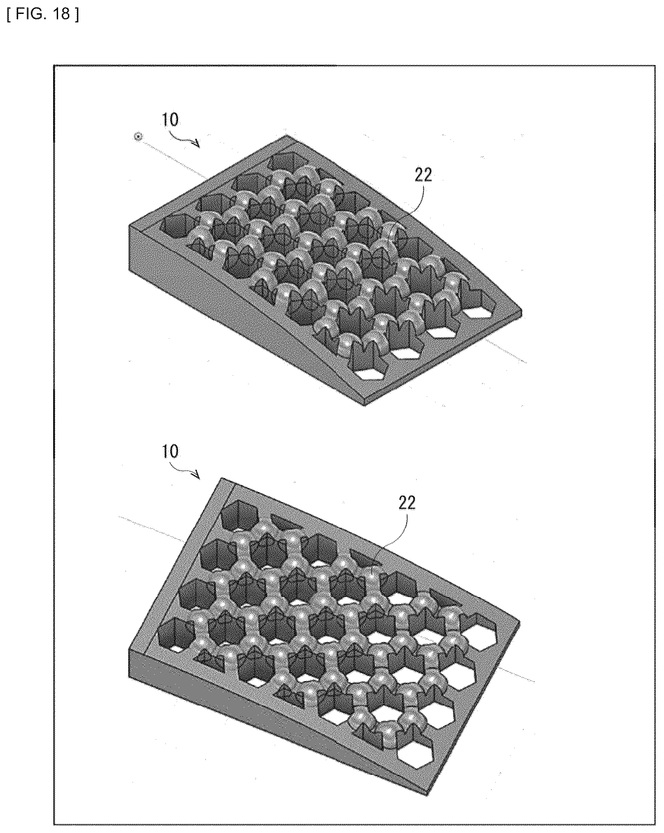

In addition, only a portion of the front surface of the gel 10 may be provided with a semispherical protrusion 22 as illustrated in FIG. 18. This not only makes an initial slip likely to be detected but also causes the protrusion 22 to serve as a slip resistance to improve holding stability.

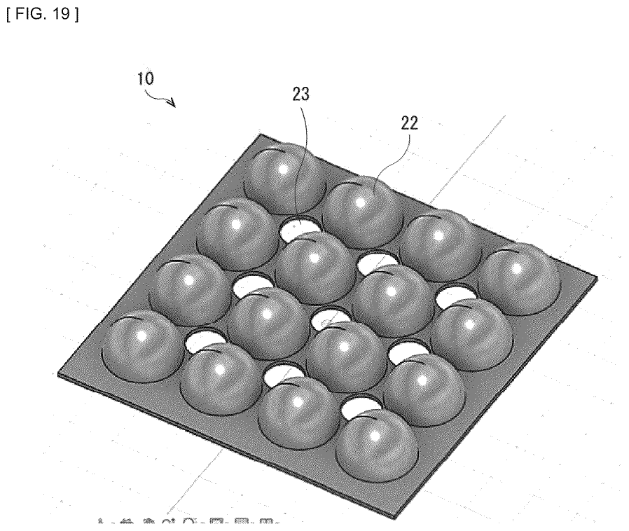

In addition, the shape of the hole 11 in the gel 10 is not limited to a quadrangle and a hexagon and a circular hole 23 may be made as illustrated in FIG. 19. In addition, a portion of the gel 10 corresponding to the protrusion 22 of the front surface may be in a shape such as a hemisphere, a trapezoid, or a rectangular parallelepiped.

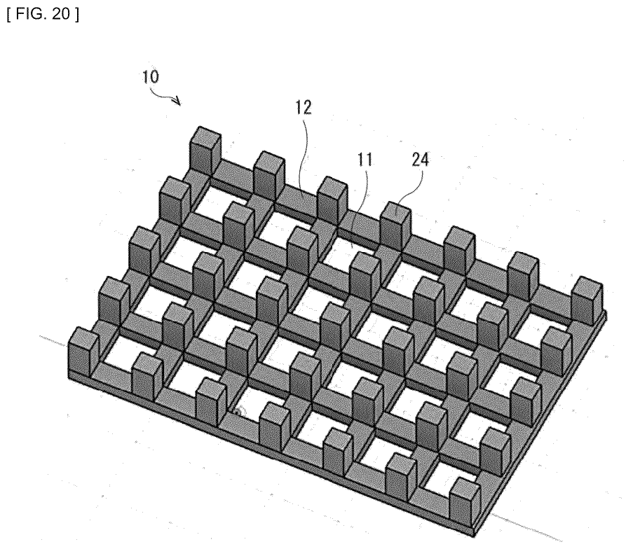

In addition, a rectangular fine protrusion 24 may be arranged at a portion of the front surface of the gel 10 as illustrated in FIG. 20. In addition, a finely shaped substance like hair may be arranged at a portion of the front surface. The arrangement of such a fine protrusion 24 or a finely shaped substance makes the front surface of the gel 10 likely to be deformed, so that it is possible to detect contact or a displacement in a shearing direction with a higher sensitivity.

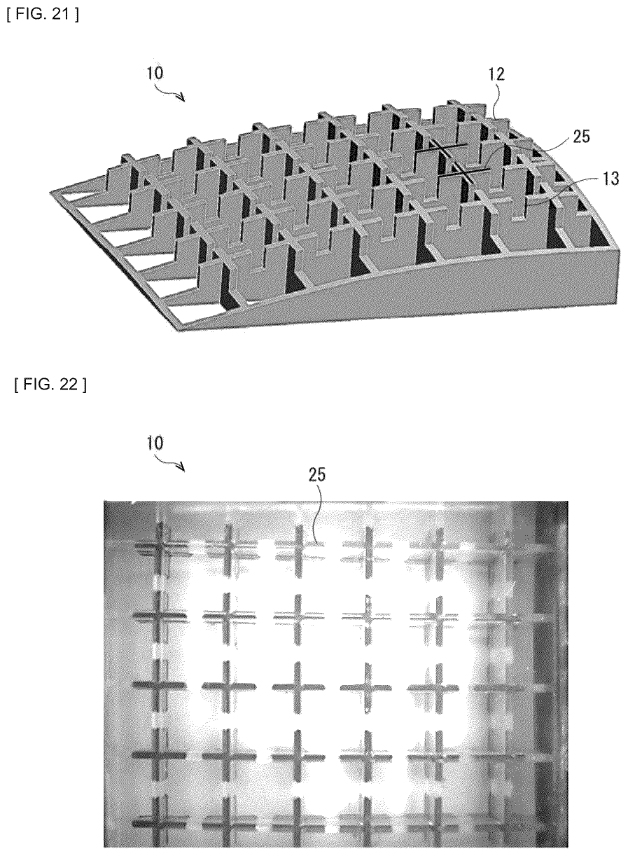

FIG. 21 schematically illustrates a configuration example where the front surface of the gel 10 of the sensor device 3 is partially provided with a colored part 25. FIG. 22 illustrates an example of an image of the gel 10 observed in a case where the front surface of the gel 10 is partially provided with the colored part 25.

As illustrated in FIG. 21, at least a portion of the front surface or a bottom surface of the gel 10 may be provided with the colored part 25. At least the portion of the front surface or the bottom surface of the gel 10 is colored, which facilitates observation of the colored part 25 as illustrated in FIG. 22. This makes the deformation of the gel 10 likely to be observed to improve detection stability. In addition, respective colored parts 25 colored with different colors may be provided at at least a portion of the front surface of the gel 10 and at least a portion of the bottom surface thereof. At least the portion of the front surface of the gel 10 and at least the portion of the bottom surface thereof gel 10 are colored with different colors, which makes a deformation in the shearing direction likely to be detected.

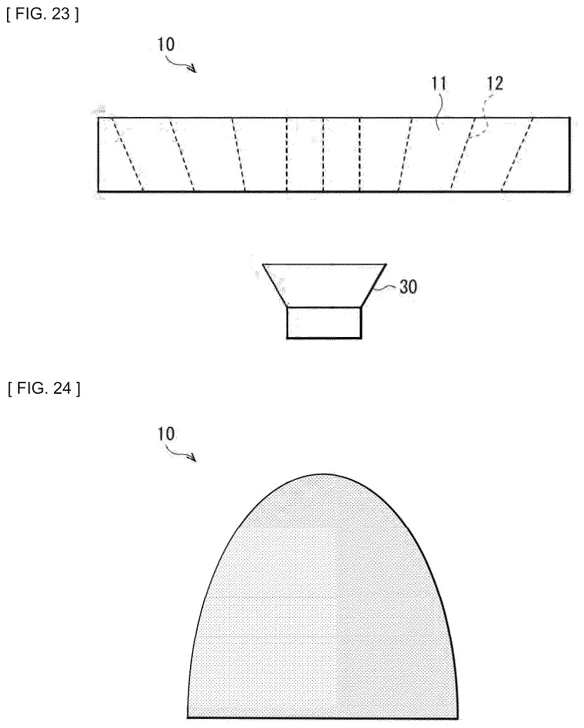

FIG. 23 schematically illustrates a modification example of the configuration of the gel 10 in the sensor device 3. FIG. 23 illustrates an example of the gel 10 as seen in a lateral direction (a cross-sectional direction).

As illustrated in FIG. 23, the plurality of holes 11 may be in respective shapes causing respective directions of the plurality of holes 11 to be toward the imaging device 30 as approaching, as the gel 10 being seen in the lateral direction (the shearing direction), the bottom surface (the rear surface) from the front surface. The outside world thus has a reduced width blocked by the gel 10 as seen from the imaging device 30 side and observation of the outside world is facilitated.

FIG. 24 schematically illustrates a modification example of the configuration of the gel 10 in the sensor device 3. FIG. 24 illustrates an example of the gel 10 as seen in the lateral direction.

The whole of the gel 10 may be in a shape allowing the gel 10 to be used directly as the finger 2. In other words, the shape of the whole of the gel 10 may be in a shape comparable to the finger 2. This allows for detecting proximity and contact relative to the object 4 in all directions.

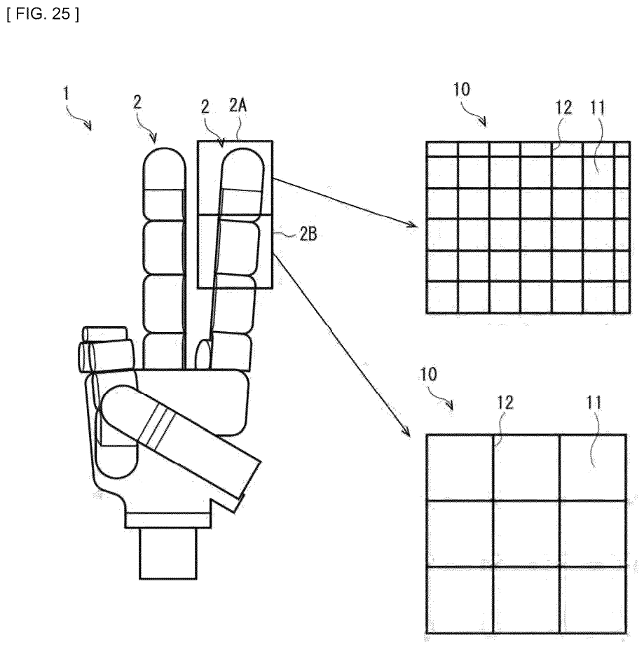

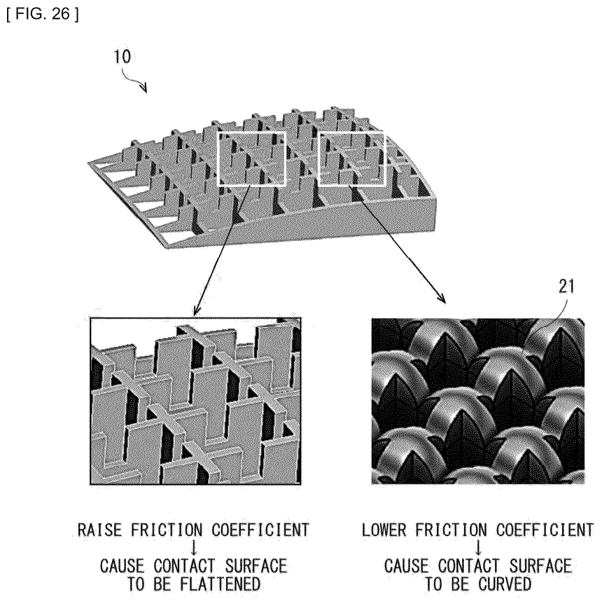

FIG. 25 schematically illustrates a modification example of the configuration of the gel 10 in the sensor device 3. FIG. 25 illustrates an example in a case where the gel 10 has the grid structure.

The configuration of the gel 10 may be changed in accordance with a location where the sensor device 3 is to be provided. For example, a density of the grid of the gel 10 may be increased at a location where a high contact position accuracy or slip detection accuracy is required. For example, the density of the grid may be increased at a fingertip (a distal joint) 2A of the finger 2 as illustrated in FIG. 25. This causes an accuracy in tactile sense to be higher than an accuracy in proximity sense at the fingertip 2A. In contrast, at a location not requiring a high contact position accuracy or slip detection accuracy, the density of the grid of the gel 10 may be decreased. For example, the density of the grid may be decreased at a side below the fingertip 2A, for example, a middle joint 2B of the finger 2 or the like, as illustrated in FIG. 25. This causes the accuracy in the proximity sense to be higher than the accuracy in tactile sense at the side below the fingertip 2A.

FIG. 26 schematically illustrates a modification example of the configuration of the gel 10 in the sensor device 3.

In the single sensor device 3, the configuration of the gel 10 may be changed in accordance with location. For example, in the single sensor device 3, different friction coefficients may be distributed in the front surface of the gel 10 in accordance with location to make an initial slip likely to be detected.

Possible methods of increasing the friction coefficient include causing a portion serving as a contact surface (the front surface of the gel 10) with the object 4 to be a flat surface to increase a contact area with the object 4, forming a fine unevenness on the front surface of the gel 10, using a sticky material, and using a material with a friction coefficient that is increased by heat.

Possible methods of decreasing the friction coefficient include causing the portion serving as the contact surface with the object 4 to be a curved surface to reduce the contact area with the object 4 or using a material having properties opposite to those in a case where the friction coefficient is increased. For example, in a case where the sensor device 3 is to be provided in the fingertip 2A, a structure causing the fiction coefficient to become higher as approaching a distal end of the fingertip 2A may be employed.

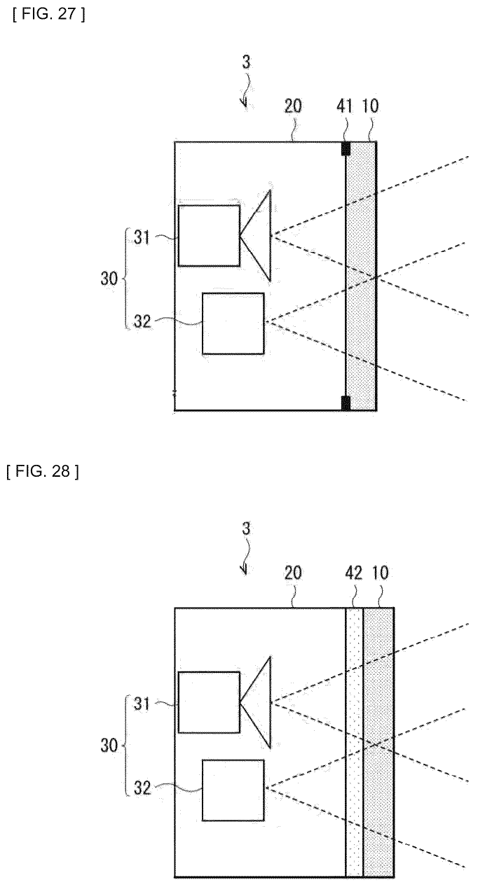

FIG. 27 and FIG. 28 schematically illustrate modification examples of the configuration of the sensor device 3. FIG. 27 and FIG. 28 illustrate examples of a method of bonding the sensor structure 20 and the gel 10.

For example, only an outer peripheral portion 41 of the gel 10 may be bonded as a bonded portion 41 to the sensor structure 20 of the sensor device 3 as illustrated in FIG. 27.

In addition, for example, a transparent plate-shaped substance 42 such as a gel sheet may be provided to stick the gel 10 to the sensor structure 20 as illustrated in FIG. 28. In terms of contact sensitivity, the measures in which the gel 10 is stuck to the sensor structure 20 with the transparent plate-shaped substance 42 in between is preferable. This facilitates the deformation of the gel 10. In addition, waterproof properties are enhanced by providing the transparent plate-shaped substance 42, which allows for water washing.

### 1.2 Sensing

The color image sensor 31 in the sensor device 3 may include an RGB camera, a pinhole camera, an IR (infrared) sensor, an event camera, or the like. A microlens array or the like may be disposed in the color image sensor 31.

In order to clearly observe each of the deformation of the gel 10 and the outside world, the sensor device 3 may have a depth of field or a focal length that is changed in accordance with whether the deformation of the gel 10 or the outside world is to be observed. In this case, the plurality of color image sensors 31 may be used or the depth of field or the focal length of the single color image sensor 31 may be automatically changed. In addition, the depth of field or the focal length may be changed in accordance with the distance information from the Depth sensor serving as the distance sensor 32. Adjusting the depth of field to be shallow to focus on distant objects causes the gel 10 to blur with a suitability for observation of the outside world and thus the object recognition rate is improved. In contrast, adjusting the depth of field to be shallow to focus on nearby objects causes a background to blur as the gel 10 is centrally focused on and thus the recognition rate of the gel 10 is improved.

The distance sensor 32 in the sensor device 3 may include an RGB-D camera, a ToF (Time of Flight) sensor, a dToF (Direct Time of Flight) sensor, a LiDAR (Light Detection and Ranging), a stereovision, or the like. In addition, the distance sensor 32 may include a sensor with patterned irradiation, a sensor that estimates a distance from a blurred image, an ultrasonic sensor, or the like.

As the gel 10 is not deformed before coming into contact with the object 4, a process to ignore a portion corresponding to the gel 10 may be performed in the sensor device 3 in a case where the outside world is to be observed. In this case, for example, a location of the gel 10 in a captured image may be stored in advance to perform the process to ignore the portion corresponding to the gel 10 in the captured image.

FIG. 29 illustrates an example of a method of estimation of a distance by the sensor device 3.

For example, it is also possible to estimate a distance from an appearance of a pattern of shadow created by the gel 10 when irradiation with light from the illumination light source 16 such as an LED is performed as illustrated in FIG. 29. For example, in a case where the gel 10 has the grid structure, a pattern of shadow of the grid becomes rough (a grid spacing becomes wide) at a short-distance position P1, whereas a pattern of shadow of the grid becomes thick (a grid spacing becomes narrow) at a long-distance position P2.

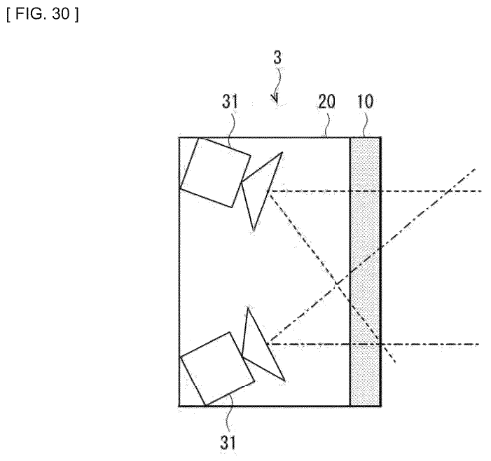

FIG. 30 to FIG. 34 schematically illustrate modification examples of the configuration of the sensor device 3.

In the sensor device 3, the portion corresponding to the gel 10 in a captured image may be caused to become unnoticeable by disposing the plurality of color image sensors 31 to cause shooting angles to differ and combining a plurality of images captured from the different angles as illustrated in FIG. 30.

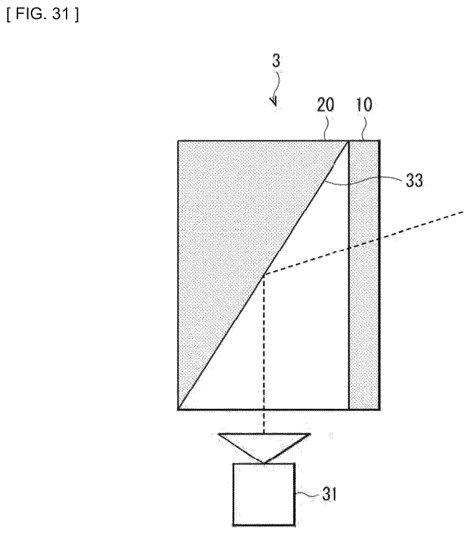

In addition, in the sensor device 3, a mirror 33 may be provided in the sensor structure 20 to cause the color image sensor 31 to capture an image via the mirror 33 as illustrated in FIG. 31.

In addition, in a case where it is possible to simultaneously measure an RGB image and a distance as illustrated in FIG. 32, the color image sensor 31 and the distance sensor 32 may be provided by a common sensor in the sensor device 3. For example, the RGB-D camera 34 may be used. The RGB-D camera 34 is a camera allowed to acquire an RGB image and a Depth image.

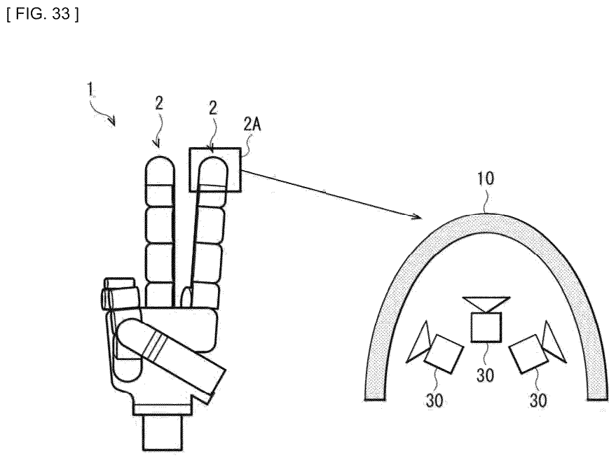

In addition, in the sensor device 3, the sensor structure 20 and the gel 10 may have a finger-shaped structure as a whole with a plurality of imaging devices 30 disposed with respect to the single sensor device 3 as illustrated in FIG. 33. This makes it possible to widen the field of view of the sensor device 3.

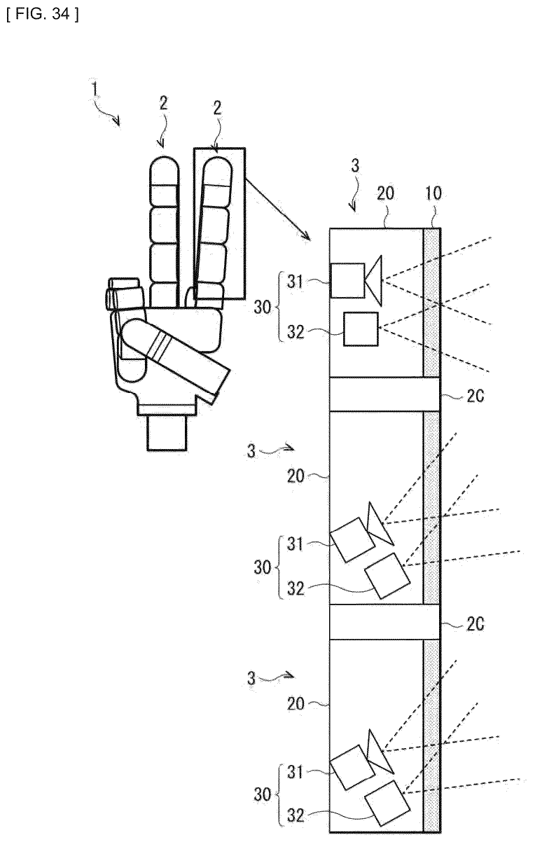

In addition, it is also possible to combine a plurality of sensor devices 3 to form the finger 2 of the robot 5. For example, the plurality of sensor devices 3 may be disposed with a knuckle 2C in between as illustrated in FIG. 34. In this case, dispositions of the imaging devices 30 may be changed in accordance with locations of disposition of the sensor devices 3 to change the shooting angles in accordance with the locations of disposition.

### 1.3 Object Recognition

Ideally, the sensor device 3 may first learn an RGB image in the state with no gel 10 through an object recognition network as described above. Then, while a learning result through the object recognition network in the state with no gel 10 is taken into account, an RGB image obtained in the state with the gel 10 may be learnt through the object recognition network (FIG. 9). This facilitates the learning. In this case, the sensor device 3 may recognize, for example, a position of the object 4, an object region mask (segmentation), and a class classification result of the object 4.

### 1.4 Distance Measurement

FIG. 35 schematically illustrates an example of measures of distance measurement by the sensor device 3.

In a case where, for example, a dToF sensor, a dToF LiDAR, or the like is used as the distance sensor 32 for distance measurement, the sensor device 3 may ignore data regarding a portion covered by the gel 10 (data regarding a reflected wave L2 from the gel 10) in obtained sensor data. This makes it possible to accurately acquire data regarding a reflected wave L1 from the object 4 to perform distance measurement.

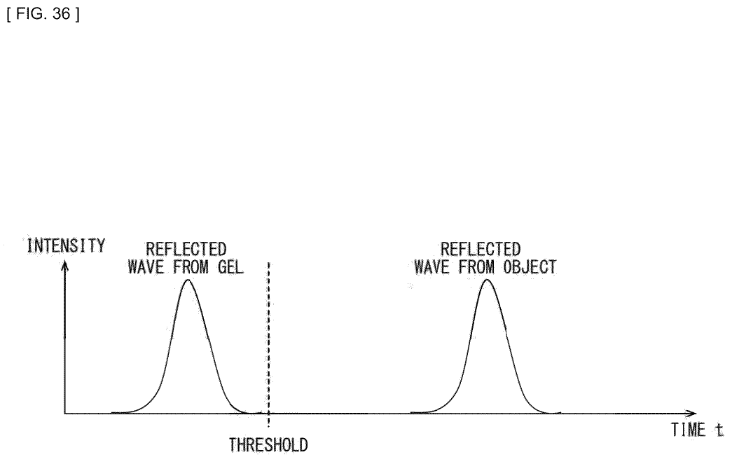

FIG. 36 schematically illustrates an example of a relationship between the reflected wave L2 from the gel 10 and the reflected wave L1 from the object 4 and the reflected waves L1 and L2 are detected in a case where distance measurement is to be performed by the sensor device 3.

In a case where, for example, a dToF sensor, a dToF LiDAR, or the like is used as the distance sensor 32 in the sensor device 3, a threshold of time to acquire sensor data is set, which makes it possible to separate the reflected wave L1 from the object 4 from the reflected wave L2 from the gel 10 in a histogram in the sensor data as illustrated in FIG. 36.

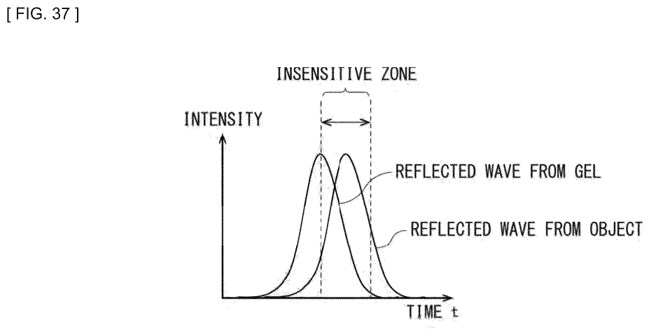

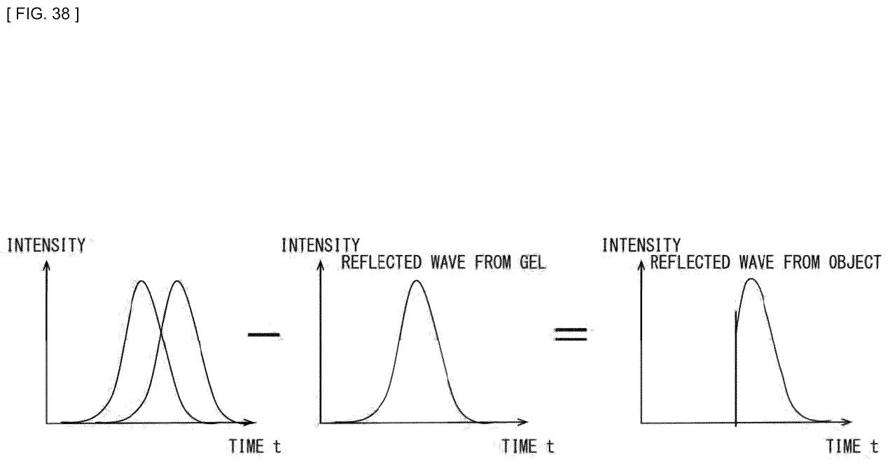

FIG. 37 and FIG. 38 schematically illustrate examples of measures of separating the reflected wave L2 from the gel 10 from the reflected wave L1 from the object 4 in the sensor device 3.

An increase in the proximity of the object 4 to the front surface of the gel 10 makes it difficult to separate the reflected wave LI from the object 4 from the reflected wave L2 from the gel 10. In this case, an insensitive zone may be provided so that the gel 10 is considered to be almost in contact as illustrated in, for example, FIG. 37. In addition, the reflected wave LI from the object 4 may be extracted by storing the reflected wave L2 from the gel 10 in advance and subtracting the reflected wave L2 from the gel 10 from the sensor data as illustrated in FIG. 38.

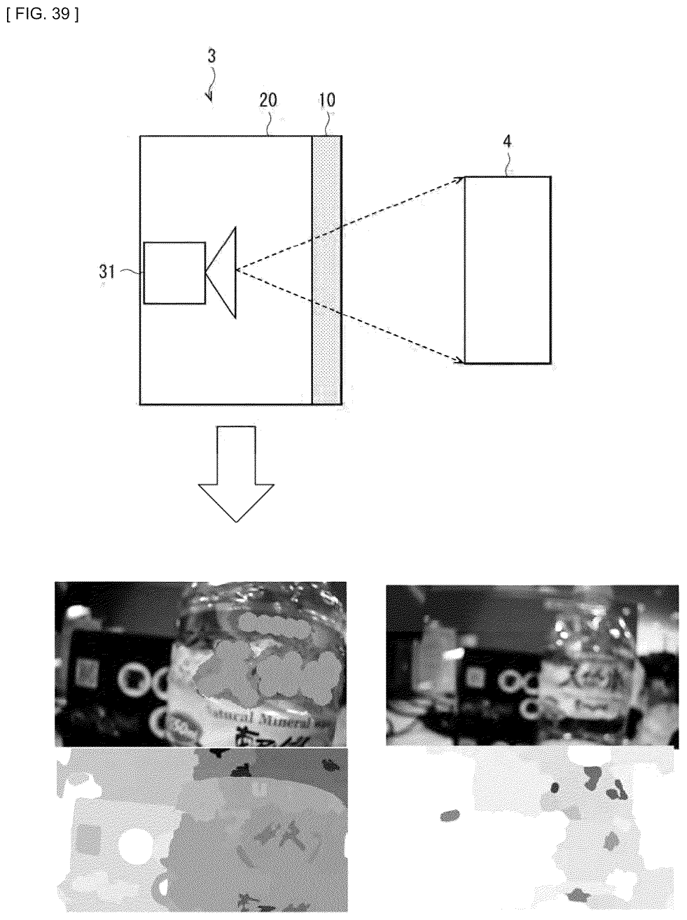

FIG. 39 to FIG. 43 schematically illustrates modification examples of the measures of distance measurement by the sensor device 3.

In a case where an RGB camera is used as the color image sensor 31 in the sensor device 3, variations in the amount of blur with distance may be used to estimate a distance from a blurred image as illustrated in, for example, FIG. 39.

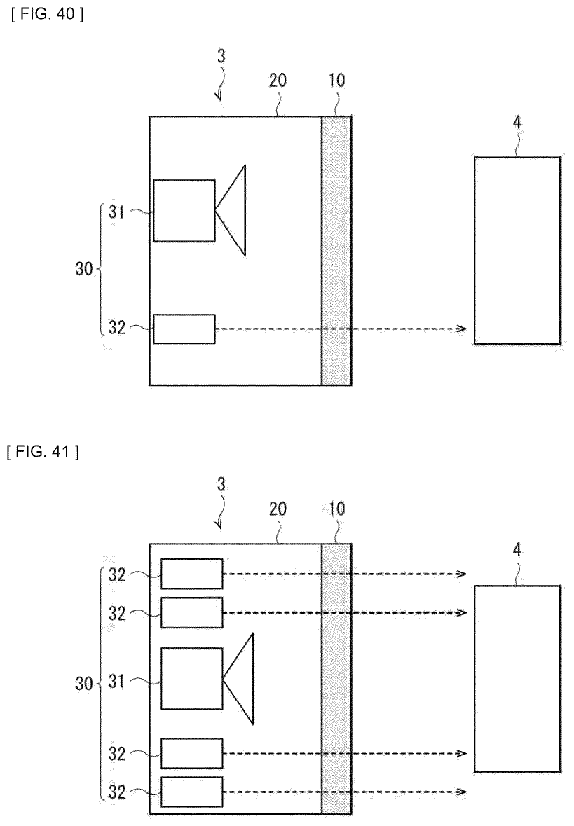

In addition, in a case where a distance is to be estimated from the amount of blur of an image using the color image sensor 31 in the sensor device 3, a distance to a point measured by, for example, a ToF sensor serving as the distance sensor 32 is further used as a reference as illustrated in, for example, FIG. 40, which makes it possible to enhance a distance estimation accuracy.

In addition, in addition, in a case where a distance is to be estimated from the amount of blur using the color image sensor 31 in the sensor device 3, distances to points measured by, for example, a plurality of ToF sensors serving as the distance sensor 32 are further used as references as illustrated in, for example, FIG. 41, which makes it possible to further enhance the distance estimation accuracy.

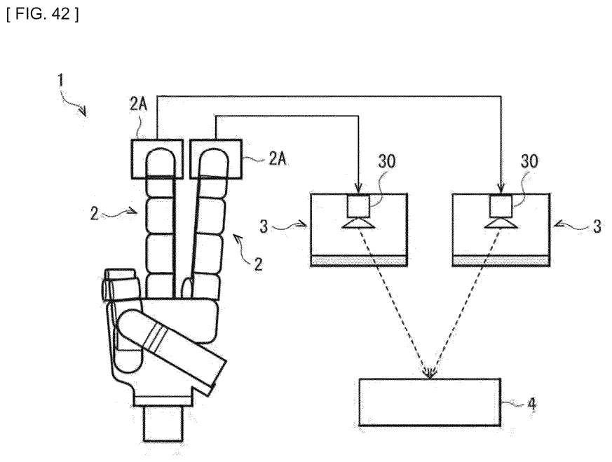

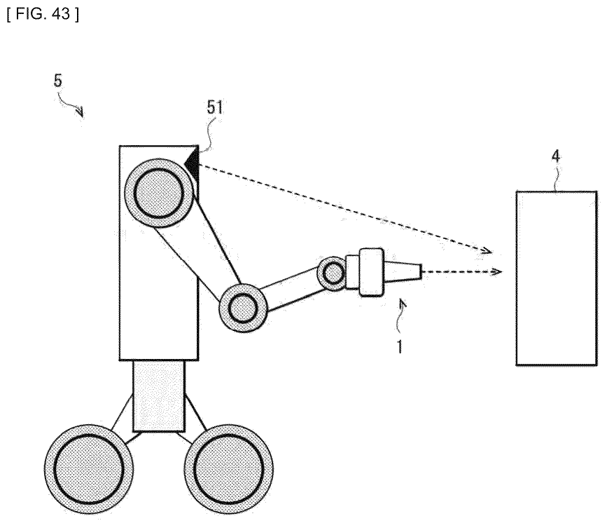

In addition, the sensor devices 3 may be attached to a plurality of fingers 2 of the robot 5 to estimate the distance to the object 4 by the principle of triangulation on the basis of sensor data obtained from the plurality of sensor devices 3 as illustrated in, for example, FIG. 42. This makes it possible to enhance the distance estimation accuracy. In addition, it is also possible to estimate the distance from an RGB image.

In addition, the distance to the object 4 may be estimated from, for example, sensor information from a head sensor 51 (for example, an image sensor) provided on a head of the robot 5 and sensor information from the sensor device 3 provided in the finger 2 of the hand 1 of the robot 5 as illustrated in, for example FIG. 43.

### 1.5 Tactile Sense

The sensor device 3 generates tactile information on the basis of a deformation image of the gel 10 as illustrated in FIG. 3. The tactile information may include, for example, a texture, information regarding an initial slip (start-to-slip detection), information regarding a whole slip, a contact position, and a contact force.

### Detection of Contact Position

FIG. 44 schematically illustrates an example of measures of detection of the contact position by the sensor device 3. FIG. 44 illustrates an example of measurement results of respective deformation images of the gel 10 resulting from applying loads of 0 g, 300 g, 600 g, and 900 g to the gel 10.

The sensor device 3 is allowed to detect a movement in the tangential direction of a deformed portion of the gel 10 on the basis of a deformation image of the gel 10 and estimate the contact position. For example, an RGB image at 0 g is considered as a reference. First, the RGB image is subjected to grayscale transformation. Subsequently, a deformed portion of the gel 10 is detected by differential information calculation. In addition, a center position of pixel values is obtained using an optical flow, which makes it possible to estimate a center (a centroid) of a contact point. This makes it possible to estimate the contact position.

### Detection of Initial Slip

FIG. 45 is a diagram of assistance in explanation of an initial slip.

An initial slip is a phenomenon where a partial slip of the contact surface with the object 4 begins from an end thereof and is also referred to as a premonitory phenomenon of slip. An initial slip region gradually expands to spread all over the contact region, which results in transition to a generally so-called “slip” (also referred to as whole slip) and, consequently, occurrence of a motion relative to the object 4 being in contact with the gel 10. Here, “fixation” refers to a state in which static friction occurs, for example, all over the contact surface between the gel 10 and a held object, or object 4, with no relative motion therebetween. Meanwhile, a “slip (whole slip)” refers to a state with a relative motion between two objects that are in contact with each other with occurrence of kinetic friction. Here, it refers to a slip with a relative motion between the gel 10 and a held object due to occurrence of kinetic friction all over the contact surface therebetween.

The “initial slip” is also referred to as a premonitory phenomenon of occurrence of the above-described slip (whole slip) and refers to a phenomenon where kinetic friction occurs at, for example, a portion of the contact surface between the gel 10 and a held object. Such an initial slip state is supposed to exist during transition from a “fixation” state to a “slip” state. In the initial slip state, no relative motion between the gel 10 and the held object occurs.

The contact region is divided into a “fixation region” where no initial slip occurs (i.e., a partial region where static friction occurs within the contact surface between the gel 11 and the held object) and a “slip region” where an initial slip occurs (i.e., a partial region where kinetic friction occurs within the contact surface between the gel 10 and the held object). The degree of slip may be indicated by a ratio between the two regions. Here, a ratio of the fixation region relative to the contact region is defined as a “fixation rate.” At a fixation rate of 1 (=100%), the contact region is in a state of being fully fixed with no slip region. Inversely, at a fixation rate of 0, the entirety of the contact region becomes the slip region, resulting in a state of suffering occurrence of a slip (a whole slip). Inversely, at a fixation rate of 0, the entirety of the contact region becomes the slip region, resulting in a state of suffering occurrence of a slip (a whole slip).

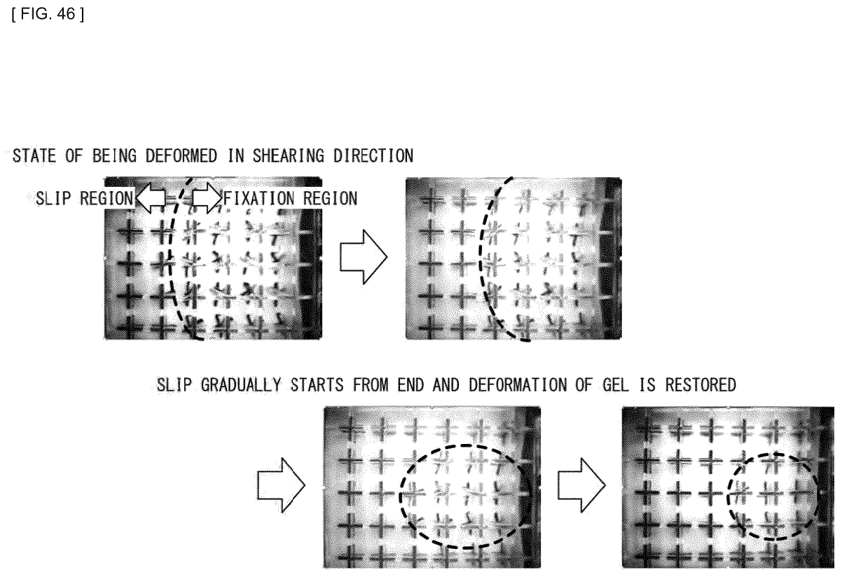

FIG. 46 schematically illustrates an example of a slip phenomenon that occurs in the gel 10 in the sensor device 3.

In the slip region, a phenomenon where the gel 10 deformed in the shearing direction is restored is seen as illustrated in FIG. 46. For example, a phenomenon where the gel 10 in a state of being deformed in the shearing direction starts gradually slipping from the end to be restored to an undeformed state is seen. Here, the “shearing direction” refers to a direction perpendicular to a normal direction of the contact surface and parallel with the contact surface. It is the same as a direction in which a slip occurs.

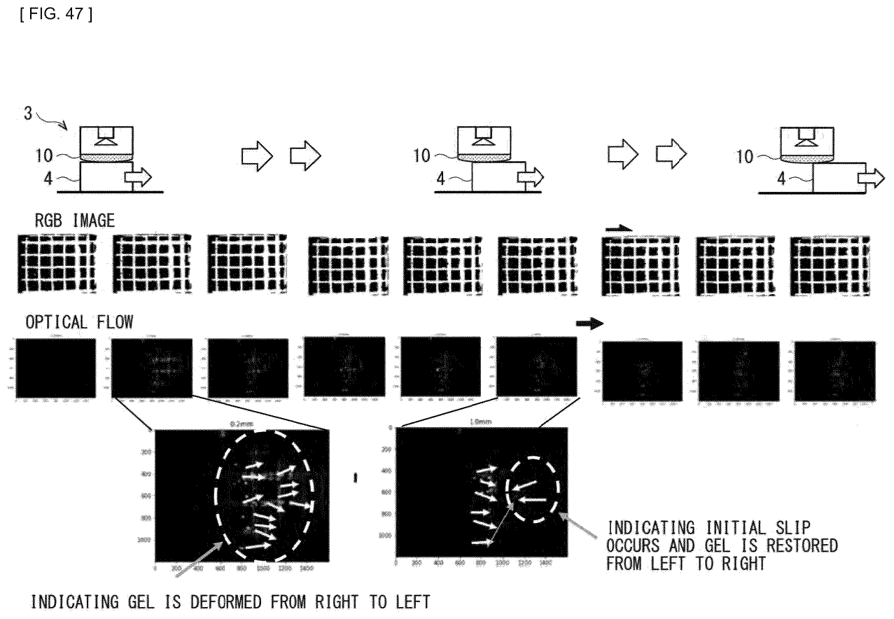

FIG. 47 schematically illustrates an example of measures of detection of an initial slip by the sensor device 3. FIG. 47 illustrates an appearance of the gel 10 being deformed in a case where the object 4 moves right with the gel 10 being pressed against the object 4.

The sensor device 3 detects an initial slip using, for example, an optical flow. Although a slip is unlikely to be detected merely by watching an RGB image, the optical flow makes the amount of shearing clear. A difference in vector direction of the optical flow makes it possible to detect an initial slip (a partial slip). In an image of the optical flow seen on the left side in the bottom tier in FIG. 47, an arrow indicates that the gel 10 is deformed from right to left against a plane of paper. In an image of the optical flow seen on the right side in the bottom tier in FIG. 47, an arrow in a portion surrounded by a broken line indicate that an initial slip occurs and the gel 10 is restored from left to right against the plane of paper.

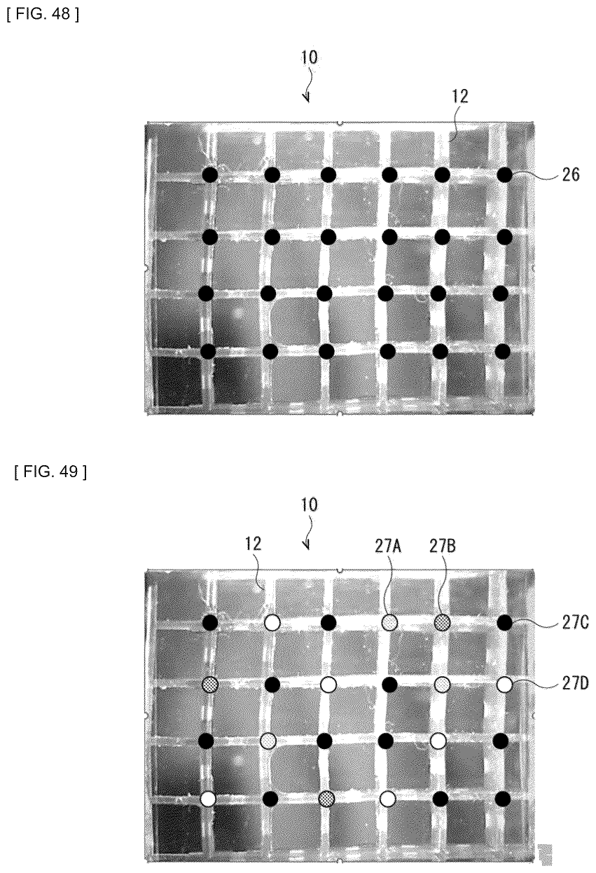

Referring to FIG. 48 to FIG. 50, description is made on a configuration example of the gel 10 of the sensor device 3 suitable for detection of an initial slip. FIG. 48 to FIG. 50 illustrate examples of an image of the gel 10 observed in a case where a colored part is provided in the front surface of the gel 10.

In the sensor device 3, the front surface of the gel 10 is partially colored to provide the colored part 25 as illustrated in above-mentioned FIG. 21 and FIG. 22, which enhances a detection accuracy of the deformation of the gel 10 using an optical flow. Here, the colored part 25 in a circular pattern tends to provide a higher detection accuracy than that in a linear pattern. Accordingly, the circular colored part 26 may be provided on the front surface of the gel 10 as illustrated in FIG. 48.

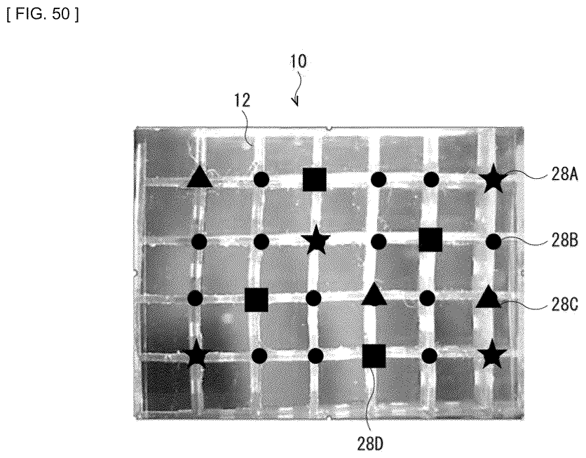

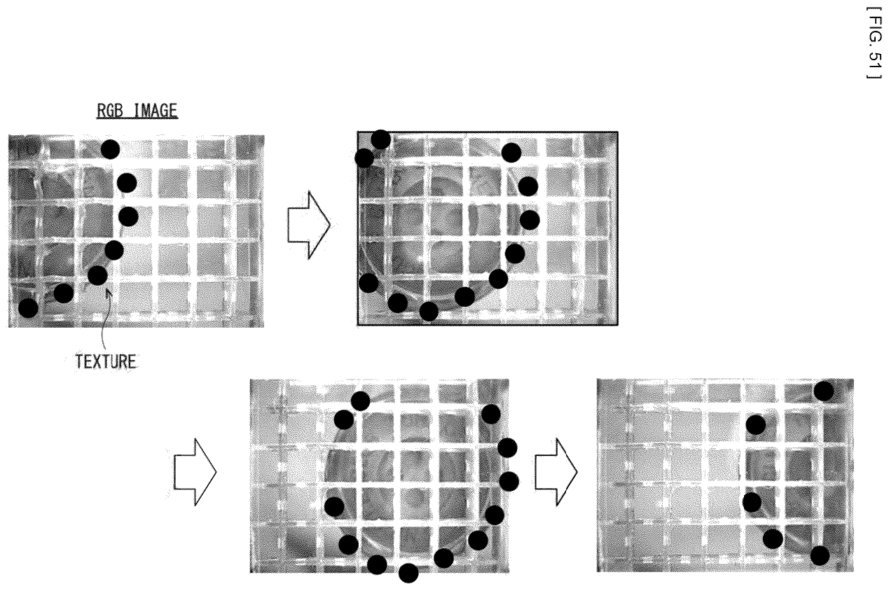

In addition, tracking of each pattern is stabilized by changing the color of the colored part 25 or changing the shape of the pattern of the colored part 25 as illustrated in FIG. 49 and FIG. 50. For example, a plurality of colored parts 27A, 27B, 27C, and 27D different in color from one another is provided as illustrated in FIG. 49, which makes it possible to constantly and stably detect the deformation of the gel 10 irrespective of a color of the background of the outside world. In addition, for example, a plurality of colored parts 28A, 28B, 28C, and 28D different in shape (pattern) from one another is provided as illustrated in FIG. 50, which stabilizes tracking of each pattern.

### Texture Detection and Detection of Whole Slip

FIG. 51 schematically illustrates an example of measures of texture detection and detection of a whole slip by the sensor device 3.

The sensor device 3 may detect a texture of the object 4 from an RGB image. For example, the sensor device 3 first detects an edge or a feature amount of the object 4 from an RGB image and performs tracking. Although the gel 10 is also simultaneously detected at this time, the position of the gel 10 may be stored in advance to add a process to ignore it or a process in which, for example, detection of an edge in a horizontal direction and an edge in a vertical direction is skipped may be performed. For example, when a movement of the texture occurs, the movement amount of the texture at which a whole slip (for example, a relative movement between the finger 2 and the object 4) is considered to occur may be defined as a whole slip amount.

### Estimation of Contact Force

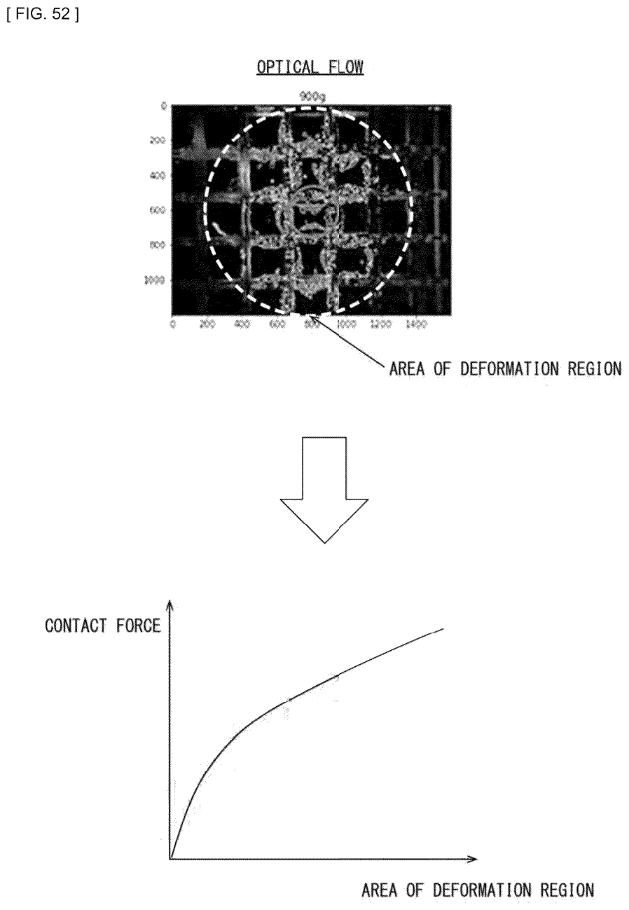

FIG. 52 to FIG. 54 illustrate first to third examples of a method of estimation of the contact force by the sensor device 3.

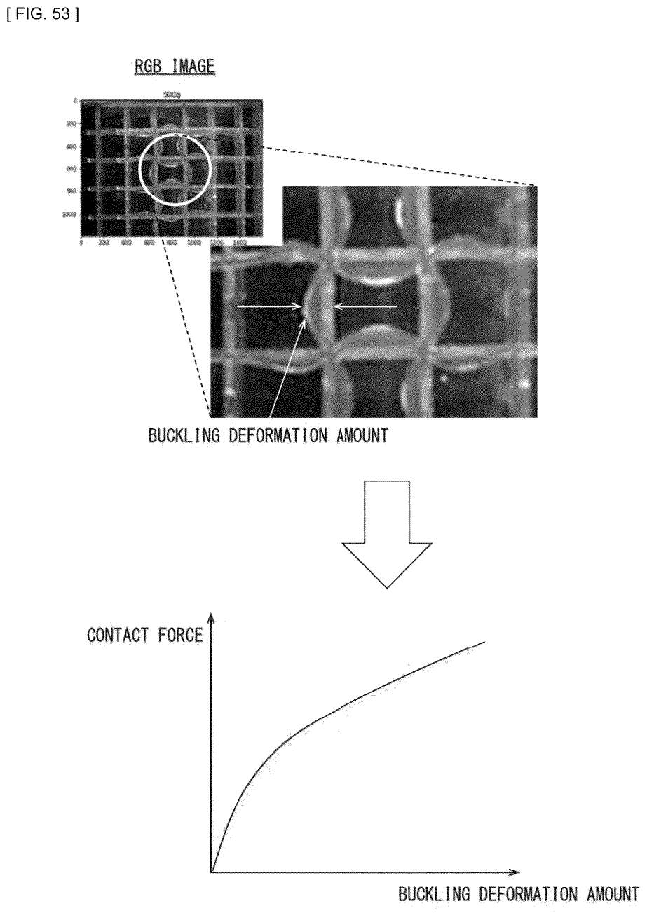

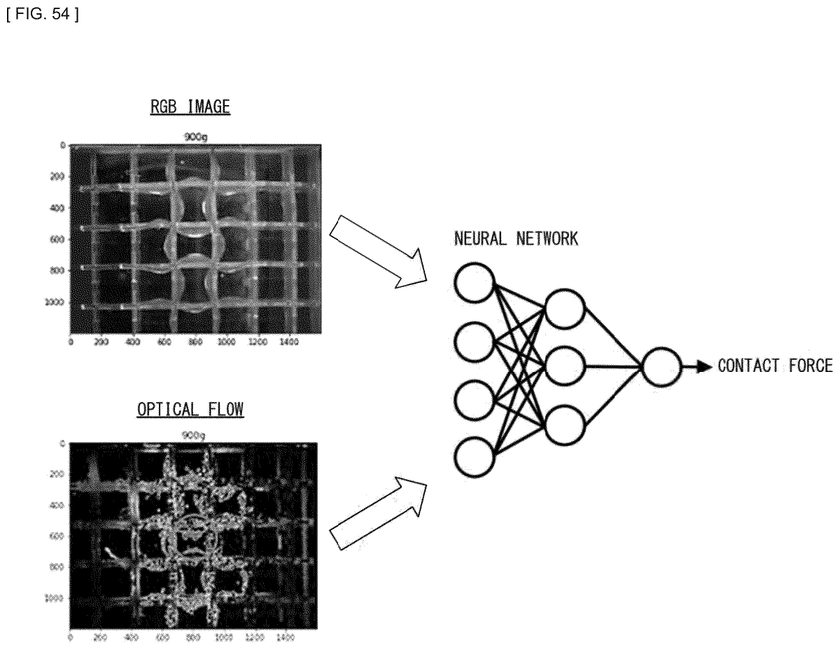

The sensor device 3 may estimate the contact force from a magnitude of the deformation of the gel 10. For example, the contact force may be estimated from an area of a deformed region as illustrated in FIG. 52. In addition, for example, the sensor device 3 may estimate the contact force from the amount of a deformation attributed to buckling as illustrated in FIG. 53. In addition, for example, the sensor device 3 may estimate the contact force with use of function approximation learnt through a neural network as illustrated in FIG. 54.

[1.6 Control of Robot]

### Execution Example of Task

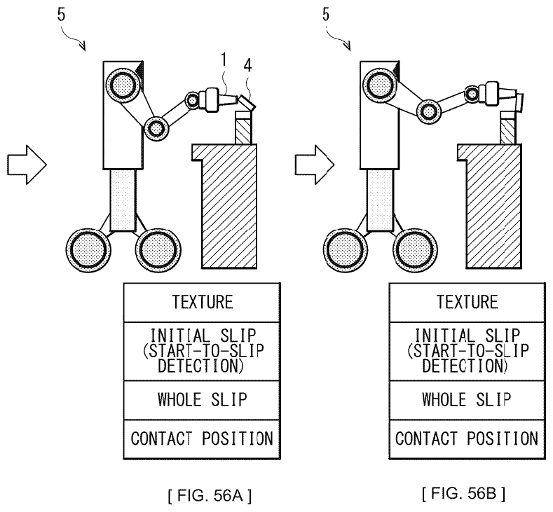

FIG. 55 and FIG. 56 illustrate an example of a modal of the sensor device 3. The modal is to be used with execution of a task by the robot 5.

The robot 5 includes a control device that performs an action control of each unit of the robot 5. The control device of the robot 5 performs the action control of each unit of the robot 5 on the basis of the sensor information from the sensor device 3 to cause the robot 5 to execute a task. The control device of the robot 5 uses an appropriate modal at an appropriate timing while switching modals of the sensor device 3 with the execution of the task.

FIG. 55 and FIG. 56 illustrate examples where the robot 5 performs a task of opening a lid of the lidded object 4. The control device of the robot 5 uses, as the modal of the sensor device 3 provided in the hand 1 and the head sensor 51, OBJECT RECOGNITION to recognize the object 4 (FIG. 55(A)). Subsequently, the control device of the robot 5 uses, as the modals of the sensor device 3 provided in the hand 1, OBJECT RECOGNITION and DISTANCE to approach the object 4 (FIG. 55(B)). Subsequently, the control device of the robot 5 uses, as the modal of the sensor device 3 provided in the hand 1, CONTACT POSITION to come into contact with the object 4 (FIG. 55(C)).

Subsequently, the control device of the robot 5 use, as the modals of the sensor device 3 provided in the hand 1, TEXTURE, INITIAL SLIP (START-TO-SLIP DETECTION), WHOLE SLIP, and CONTACT POSITION to perform the task of opening the lid of the object 4 (FIG. 56(A) and (FIG. 56(B)).

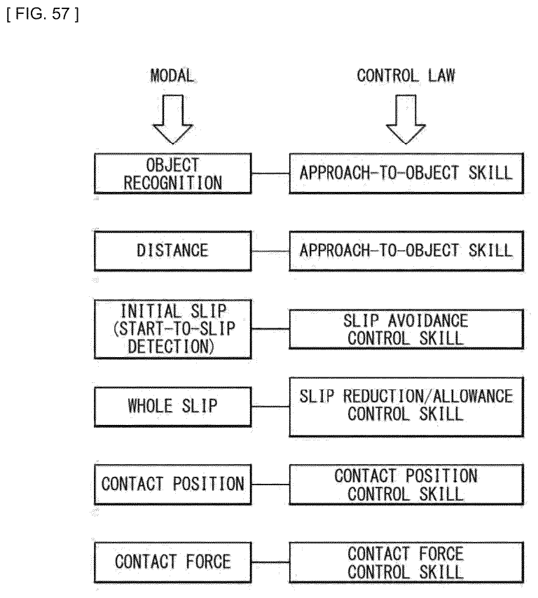

FIG. 57 illustrates an example of pairing of a modal of the sensor device 3 with a control law (a skill) of the robot 5.

The pairing illustrated in FIG. 57 is merely by way of example and, for example, a plurality of control laws may be paired with a single modal without limitation to the example in FIG. 57. In this case, the control device of the robot 5 stores, for example, switching conditions indicating which control law is to be used for each modal. The control device of the robot 5 may perform pairings such as OBJECT RECOGNITION and an approach-to-object skill, DISTANCE and the approach-to-object skill, INITIAL SLIP (START-TO-SLIP DETECTION) and a slip avoidance control skill, WHOLE SLIP and a slip reduction/allowance control skill, CONTACT POSITION and a contact position control skill, and CONTACT FORCE and a contact force control skill.

The control device of the robot 5 is allowed to execute a task by lining up the paired skills in sequence.

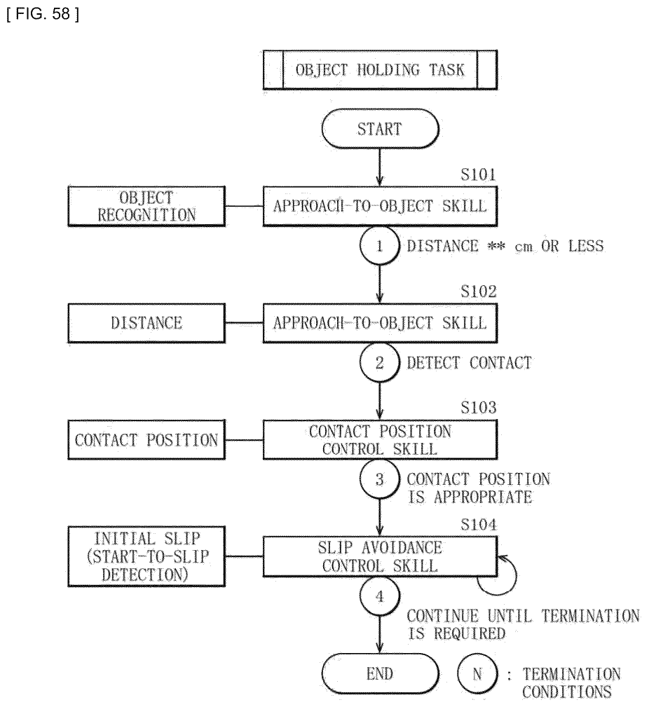

FIG. 58 is a flowchart illustrating an execution example of an object holding task by the robot 5. The respective termination conditions for the skills are defined in advance.

For the object holding task, the control device of the robot 5 first uses, as the modal of the sensor device 3, OBJECT RECOGNITION to approach the object 4 using the approach-to-object skill (Step S101) as illustrated in FIG. 58. In response to the robot 5 approaching the object 4 at a predetermined distance (for example, ** cm) or less, the control device of the robot 5 subsequently uses, as the modal of the sensor device 3, DISTANCE to approach the object 4 using the approach-to-object skill (Step S102). In response to the detection of contact with the object 4, the control device of the robot 5 subsequently uses, as the modal of the sensor device 3, CONTACT POSITION to come into contact with the object 4 using the contact position control skill (Step S103). In response to the contact position being appropriate, the control device of the robot 5 subsequently uses, as the modal of the sensor device 3, INITIAL SLIP to perform the slip avoidance control using the slip avoidance control skill until termination is required (Step S104). In response to the requirement of the termination, the control device of the robot 5 terminates the object holding task.

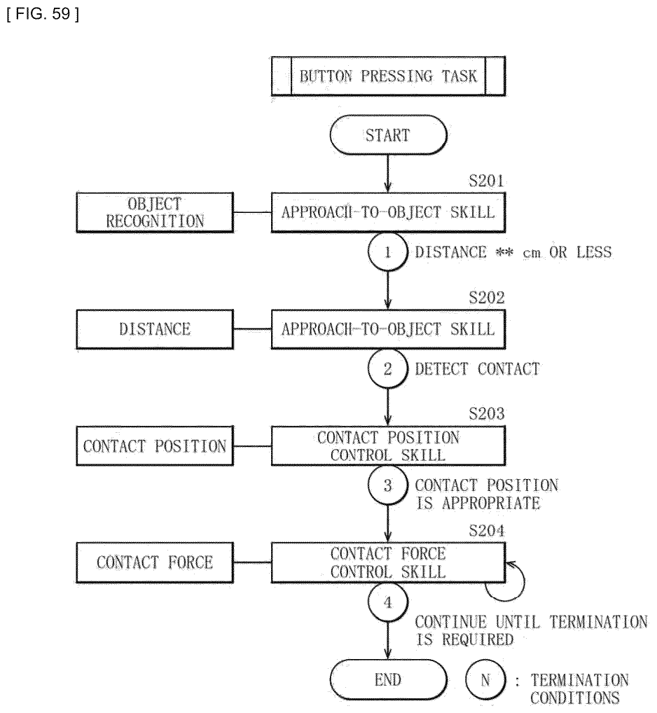

FIG. 59 is a flowchart illustrating an execution example of a button pressing task by the robot 5. The respective termination conditions for the skills are defined in advance.

For the button pressing task, the control device of the robot 5 first uses, as the modal of the sensor device 3, OBJECT RECOGNITION to approach the object 4 using the approach-to-object skill (Step S201) as illustrated in FIG. 59. In response to the robot 5 approaching the object 4 at the predetermined distance (for example, ** cm) or less, the control device of the robot 5 subsequently uses, as the modal of the sensor device 3, DISTANCE to approach the object 4 using the approach-to-object skill (Step S202). In response to the detection of contact with the object 4, the control device of the robot 5 subsequently uses, as the modal of the sensor device 3, CONTACT POSITION to come into contact with the object 4 using the contact position control skill (Step S203). In response to the contact position being appropriate, the control device of the robot 5 subsequently uses, as the modal of the sensor device 3, CONTACT FORCE to perform the contact force control using the contact force control skill until termination is required (Step S204). In response to the requirement of the termination, the control device of the robot 5 terminates the button pressing task.

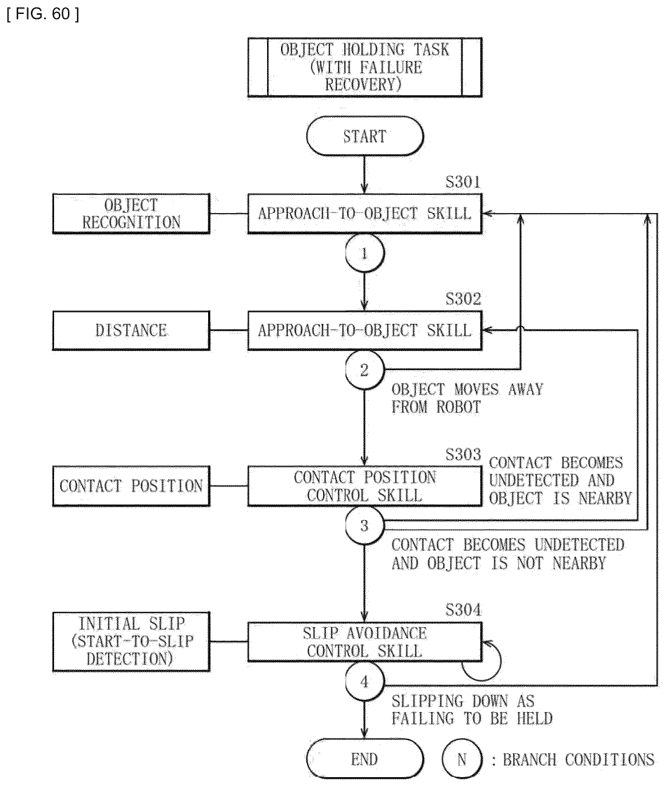

Registration of the skills in a tree-shaped makes it possible for the control device of the robot 5 to execute a moderately complicated task with a branch as illustrated in FIG. 60.

FIG. 60 is a flowchart illustrating an execution example of an object holding task (with failure recovery) by the robot 5. Respective branch conditions for the skills are defined in advance.

The control device of the robot 5 first uses, as the modal of the sensor device 3, OBJECT RECOGNITION to approach the object 4 using the approach-to-object skill (Step S301). The control device of the robot 5 subsequently uses, as the modal of the sensor device 3, DISTANCE to approach the object 4 using the approach-to-object skill (Step S302). Here, in response to a movement of the object 4 away from the robot 5, the control device of the robot 5 returns to the process in Step S301.

In response to the detection of contact with the object 4, the control device of the robot 5 subsequently uses, as the modal of the sensor device 3, CONTACT POSITION to come into contact with the object 4 using the contact position control skill (Step S303). Here, in a case where the object 4 is nearby though the contact becomes undetected, the control device of the robot 5 returns to the process in Step S302. Meanwhile, in a case where the contact becomes undetected and the object 4 is not nearby, the control device of the robot 5 returns to the process in Step S301.

In response to the contact position being appropriate, the control device of the robot 5 subsequently uses, as the modal of the sensor device 3, INITIAL SLIP to perform the slip avoidance control using the slip avoidance control skill until termination is required (Step S304). Here, in a case where the object 4 slips down as failing to be held, the control device of the robot 5 returns to the process in Step S301. In response to the requirement of the termination, the control device of the robot 5 terminates the object holding task.

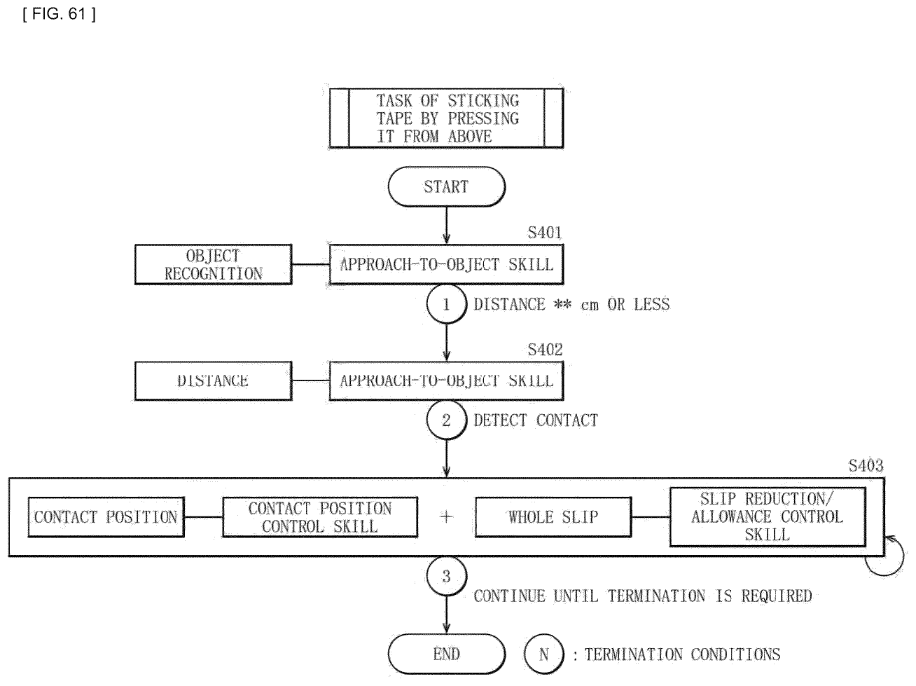

The control device of the robot 5 may simultaneously perform a plurality of the skills in parallel as illustrated in FIG. 61.

FIG. 61 is a flowchart illustrating an execution example of a task of causing the robot 5 to stick a tape by pressing it from above. The respective termination conditions for the skills are defined in advance.

The control device of the robot 5 first uses, as the modal of the sensor device 3, OBJECT RECOGNITION to approach the object 4 using the approach-to-object skill (Step S401). In response to the robot 5 approaching the object 4 at the predetermined distance (for example, ** cm) or less, the control device of the robot 5 subsequently uses, as the modal of the sensor device 3, DISTANCE to approach the object 4 using the approach-to-object skill (Step S402). In response to the detection of contact with the object 4, the control device of the robot 5 subsequently uses, as the modal of the sensor device 3, CONTACT POSITION to come into contact with the object 4 using the contact position control skill. In addition, the control device of the robot 5 uses, as the modal of the sensor device 3, WHOLE SLIP to perform a slip reduction/allowance control using the slip reduction/allowance control skill in parallel (Step S403). The control device of the robot 5 repeats the process in Step S403 until termination is required. In response to the requirement of the termination, the control device of the robot 5 terminates the task.

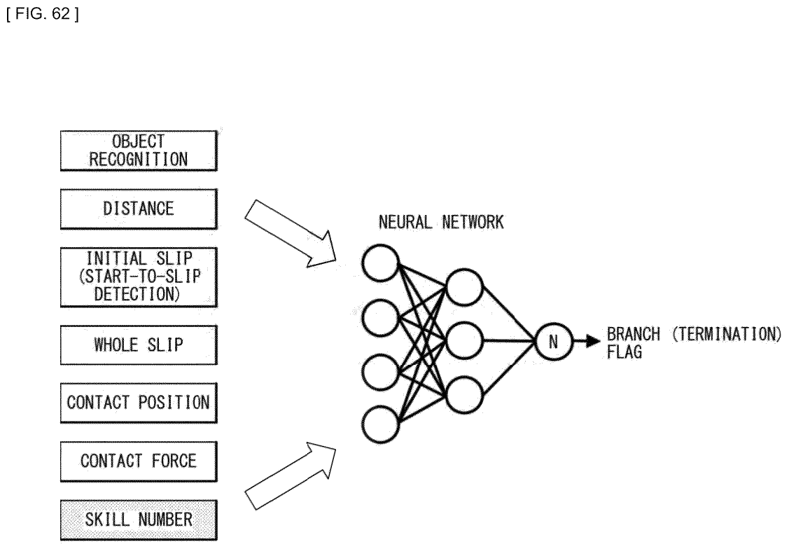

FIG. 62 illustrates an example of how to determine the termination conditions and the branch conditions for the skills in causing the robot 5 to execute a task.

The control device of the robot 5 may be caused to learn the respective termination conditions and branch conditions for the skills through a neural network. For example, information regarding each modal of the sensor device 3 and the skill number of each skill of the robot 5 may be inputted to a neural network to determine the termination conditions and the branch conditions for the skills.

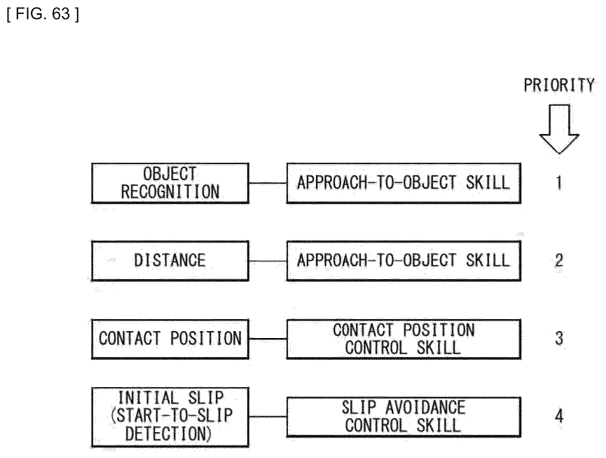

FIG. 63 illustrates an example of the setting of the priorities of the skills in causing the robot 5 to execute a task.

The control device of the robot 5 may set a priority for each of the skills. The control device of the robot 5 may more preferentially perform a higher-priority skill.

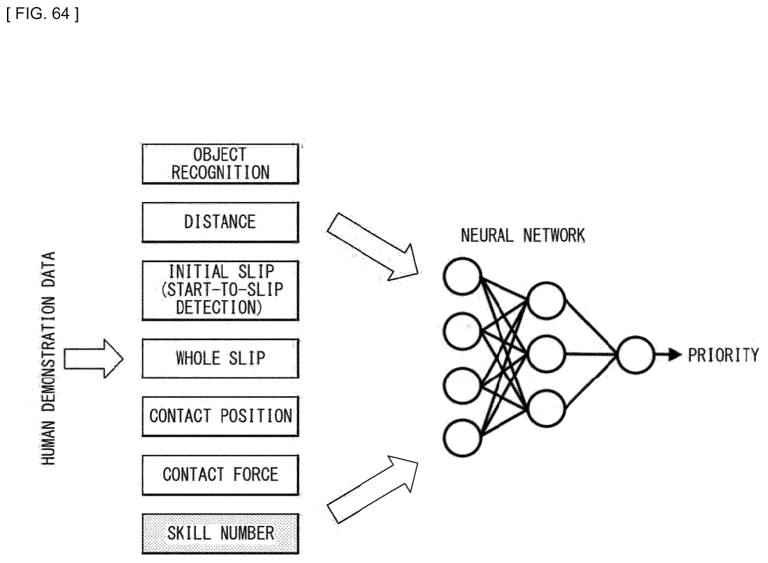

FIG. 64 illustrates an example of how to determine the setting of the priorities of the skills in causing the robot 5 to execute a task.

The control device of the robot 5 may determine the priorities by learning through a neural network. In determining the priorities, they may be determined from human demonstration data. For example, information regarding each modal of the sensor device 3 and the skill number of each skill of the robot 5 may be inputted to a neural network on the basis of the human demonstration data to determine the priorities of the skills.

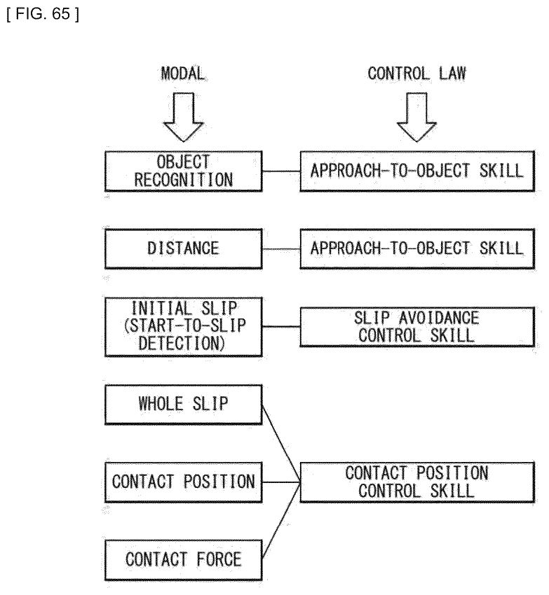

FIG. 65 illustrates an example of the pairing of a modal of the sensor device 3 with a control law (a skill) of the robot 5.

The control device of the robot 5 may create a single skill by combining a plurality of modals. For example, the contact position control skill may be created by combining, as modals, WHOLE SLIP, CONTACT POSITION, and CONTACT FORCE.

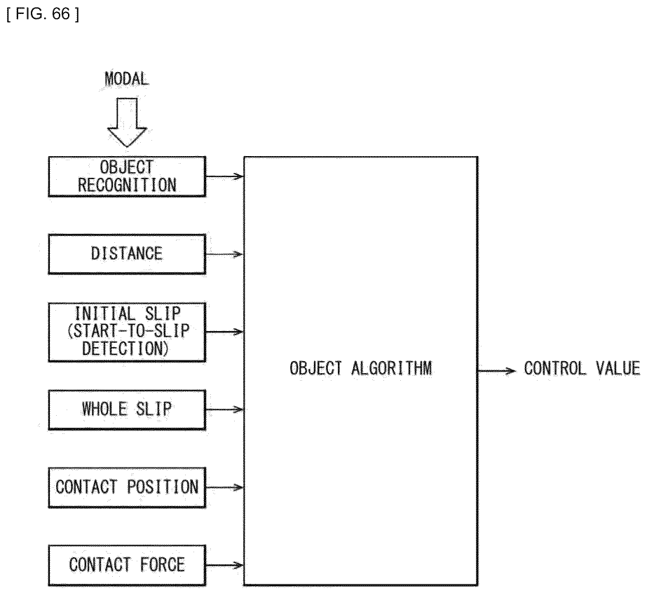

FIG. 66 illustrates an example where a control value of the robot 5 is to be outputted without paring a modal of the sensor device 3 with a control law (a skill) of the robot 5.

The control device of the robot 5 does not necessarily pair a modal with a skill. For example, the control device of the robot 5 may output the control value of the robot 5 in accordance with a predetermined control algorithm on the basis of the modal of the control sensor device 3. The predetermined control algorithm may include, for example, mathematical expression base (a model base), neural network, If-then rule base, or the like.

### Configuration Example of Control Device of Robot 5

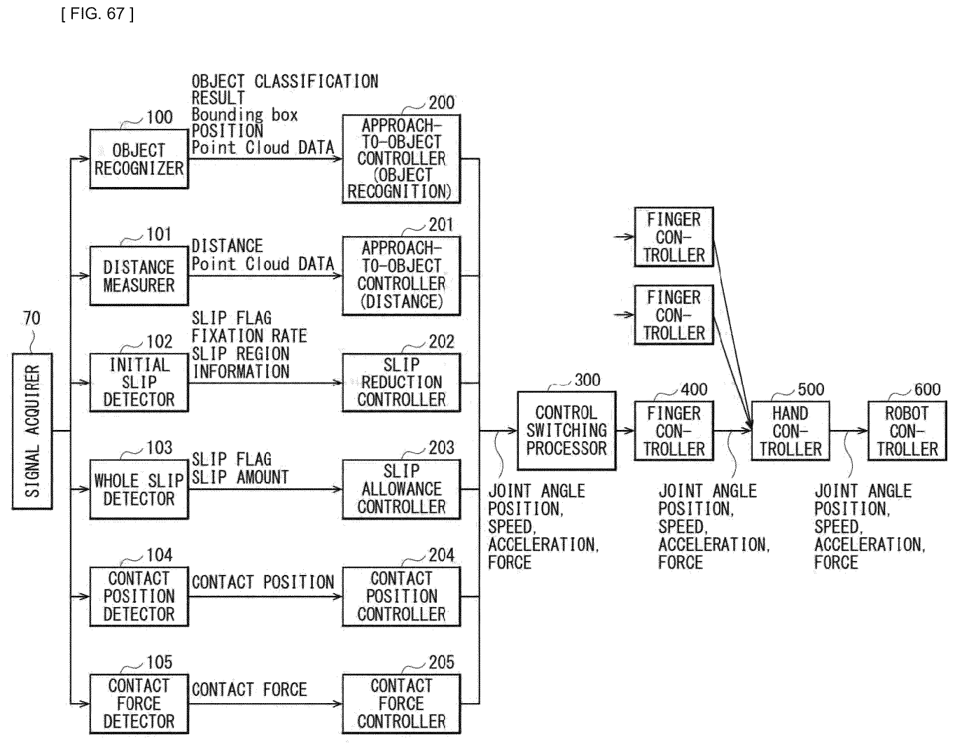

FIG. 67 illustrates a configuration example of the control device of the robot 5.

The control device of the robot 5 includes a signal acquirer 700, an object recognizer 100, a distance measurer 101, an initial slip detector 102, a whole slip detector 103, a contact position detector 104, and a contact force detector 105. The control device of the robot 5 also includes an approach-to-object controller (object recognition) 200, an approach-to-object controller 201, a slip reduction controller 202, a slip allowance controller 203, a contact position controller 204, and a contact force controller 205. The control device of the robot 5 also includes a control switching processor 300, a plurality of finger controllers 400, a hand controller 500, and a robot controller 600.

The signal acquirer 700, the object recognizer 100, the distance measurer 101, the initial slip detector 102, the whole slip detector 103, the contact position detector 104, and the contact force detector 105 may be implemented by the sensor information processor 40 of the sensor device 3.

The signal acquirer 700 acquires, as the sensor information from the sensor device 3, data such as an RGB image, an RGB-D image, Point Cloud (point cloud), a Depth image, event camera data, image change information, or a marker motion vector.

The object recognizer 100 outputs data such as an object classification result, a Bounding box position, or Point Cloud on the basis of a signal acquired by the signal acquirer 700.

The distance measurer 101 outputs, for example, data such as a distance and Point Cloud. The initial slip detector 102 outputs data such as a slip flag, a fixation rate, and slip region information. The whole slip detector 103 outputs data such as a slip flag and a slip amount. The contact position detector 104 outputs data such as the contact position. The contact force detector 105 outputs data such as the contact force.

The approach-to-object controller (object recognition) 200, the approach-to-object controller (distance) 201, the slip reduction controller 202, the slip allowance controller 203, the contact position controller 204, and the contact force controller 205 each output data such as joint angle position, speed, and acceleration, force.

Each of the plurality of finger controllers 400 outputs data such as joint angle position, speed, acceleration, and force.

The hand controller 500 outputs data such as joint angle position, speed, acceleration, and force.

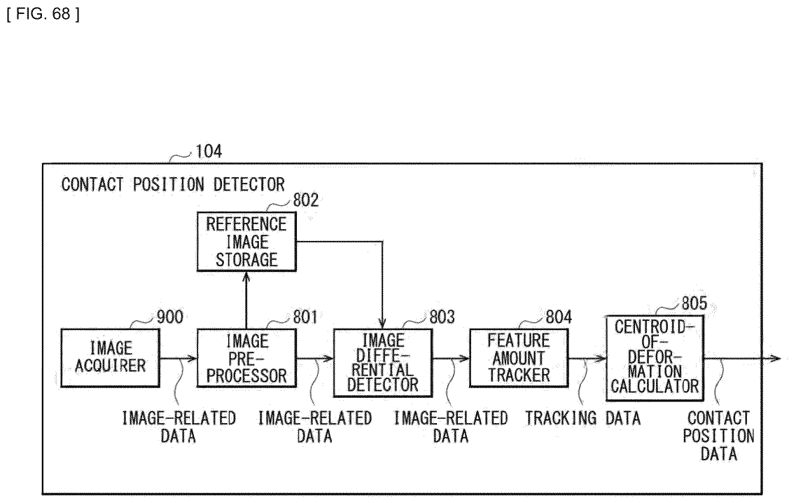

FIG. 68 illustrates a configuration example of the contact position detector 104.

The contact position detector 104 includes an image acquirer 800, an image preprocessor 801, a reference image storage 802, an image differential detector 803, a feature amount tracker 804, and a centroid-of-deformation calculator 805.

The image acquirer 800 outputs, for example, image-related data. The image preprocessor 801 outputs, for example, data regarding a reference image and image-related data. The reference image storage 802 stores, for example, the data regarding the reference image from the image preprocessor 801.

The image differential detector 803 outputs, for example, image-related data obtained from a differential between the data regarding the reference image stored in the reference image storage 802 and the image-related data from the image preprocessor 801. The feature amount tracker 804 outputs, for example, tracking data. The centroid-of-deformation calculator 805 outputs, for example, contact position data.

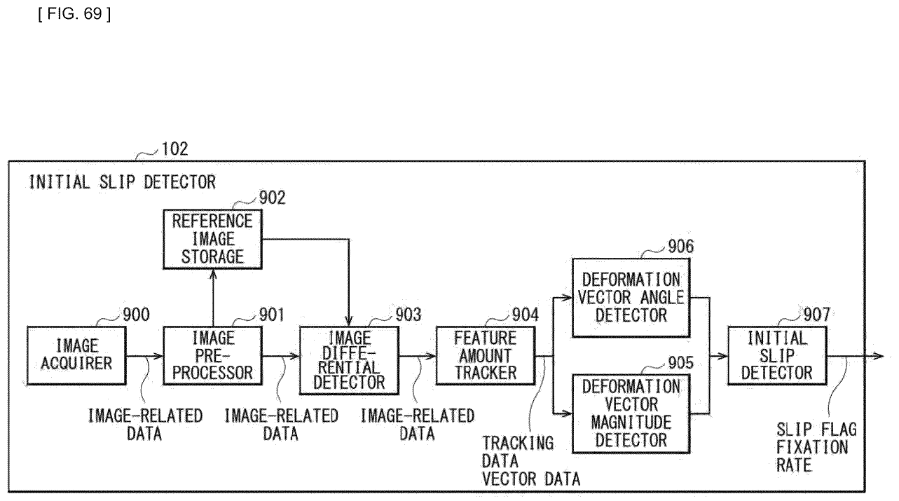

FIG. 69 illustrates a configuration example of the initial slip detector 102.

The initial slip detector 102 includes an image acquirer 900, an image preprocessor 901, a reference image storage 902, an image differential detector 903, a feature amount tracker 904, a deformation vector magnitude detector 905, a deformation vector angle detector 906, and an initial slip detector 907.

The image acquirer 900 outputs, for example, image-related data. The image preprocessor 901 outputs, for example, data regarding a reference image and image-related data. The reference image storage 902 stores, for example, the data regarding the reference image from the image preprocessor 901.

The image differential detector 903 outputs, for example, image-related data obtained from a differential between the data regarding the reference image stored in the reference image storage 902 and the image-related data from the image preprocessor 901. The feature amount tracker 904 outputs, for example, tracking data and vector data. The deformation vector magnitude detector 905 outputs, for example, data regarding a magnitude of a deformation vector. The deformation vector angle detector 906 outputs, for example, data regarding an angle of the deformation vector. The initial slip detector 907 outputs, for example, data regarding a slip flag and data regarding a fixation rate.

### 1.7 Effects

As described hereinabove, the sensor device 3 and the robot 5 according to the embodiment allow for observation of a flexible layer, or the gel 10, attached to the sensor structure 20 and observation of the object 4 in the outside world through the hole 11 of the flexible layer by virtue of the imaging device 30 installed in the sensor structure 20. This makes it possible to perform a highly accurate multimodal sensing.

The sensor device 3 and the robot 5 according to the embodiment allow for implementation of a function as a tactile sensor that acquires tactile information on the basis of deformation information regarding the flexible layer observed via the imaging device 30 and a function as a proximity sensor that acquires proximity information on the basis of observation information regarding the object 4 observed through the hole 11 of the flexible layer. In the sensor device 3 according to the embodiment, the hole 11 is made in the gel 10, which facilitates the deformation of the gel 10. In the sensor device 3 according to the embodiment, a plurality of pieces of information is acquirable merely by the single sensor device 3, which makes it possible to save an installation space in the robot 5. In addition, a highly sensitive tactile sensor and a high-resolution proximity sensor are allowed to be simultaneously implemented merely by the single sensor device 3, which makes it possible to achieve a more stable and accurate manipulation action.

In the sensor device 3 and the robot 5 according to the embodiment, the single sensor device 3 is allowed to acquire a plurality of modals. As the plurality of modals is acquirable, a complicated robot action becomes possible. In addition, as the plurality of modals is acquirable, detection of a failure and recovery therefrom become possible, which allows for an action in an environment with a highly uncertain environment. In addition, as the plurality of modals is acquirable, the necessity of installing an additional sensor is eliminated and space efficiency is improved.

In addition, in the sensor device 3 according to the embodiment, the use of an image-based sensor causes space resolution to be high, which makes it possible to raise sensitivities to contact, slip, and the like. In addition, the sensor device 3 according to the embodiment is allowed to exhibit both of proximity sense and tactile sense without the necessity of sacrificing the respective detection accuracies. In addition, the sensor device 3 according to the embodiment is free from a large influence of wearing of the contact surface of the sensor device 3 (the front surface of the gel 10) on the accuracies in proximity sense and tactile sense. In addition, in the sensor device 3 according to the embodiment, separation between an imaging system and the front surface of the gel 10 is possible, so that replacement of the imaging system and the gel 10 is easy and maintainability and expandability are high. In addition, in the sensor device 3 according to the embodiment, it is possible to change the characteristics of the sensor as a whole by changing the shape of the gel 10, so that characteristics of the sensor as a whole are easily changeable in accordance with the purpose of use.

In addition, in the robot 5 according to the embodiment, a control block is divided (paired) on a modal-by-modal basis, which facilitates adjustment of a control parameter. The modal-based division of the control block facilitates disablement of a control of a malfunctioned modal, which makes the malfunction unlikely to have an influence on the entirety of the control. The modal-based division of the control block makes it possible to modularize the control block, which allows for a versatile use for various purposes of use.

Comparison with Related Art

A technique according to PTL 1 (International Publication No. WO 2009/144767) relates to a sensor including a pressure-sensitive sheet and a proximity sensor installed in a hole penetrating the pressure-sensitive sheet and the sensor allows for both detection of a contact pressure and a proximity sense, or distance measurement. In the technique according to PTL 1, the hole is made in the pressure-sensitive sheet, so that a pressure-sensitive region is reduced with an increase in the number of holes with a detection accuracy decreased. In addition, the space resolution in proximity sense and the accuracy of contact detection have a trade-off relationship due to a balance with a hole size. In addition, the pressure-sensitive sheet and the proximity sensor are integrated and difficult to separate. This makes it difficult to maintain the sensor, replace the pressure-sensitive sheet, and change a shape design of the pressure-sensitive sheet.

In contrast to the above, in the sensor device 3 according to the embodiment, the employment of the meshed structure of the compliant material (the gel 10) eliminates the trade-off between the region of the proximity sense and the region of the tactile sense, which makes it possible to simultaneously raise the accuracies of the plurality of modals. By virtue of the hole 11 having a large structure, object recognition using an image also becomes possible. In addition, the separation between the compliant material and the imaging system makes replacement easy, so that maintainability and expandability are high.

A technique according to PTL 2 (Japanese Unexamined Patent Application Publication No. 2018-9792) relates to a sensor having both a proximity function to detect a distance to an object in a non-contact manner on the basis of a change in capacitance and a tactile function to detect a change in magnetism attributed to a displacement of a magnetic body responsive to an external force. In the technique according to PTL 2, detection of a proximity sense is based on a change in capacitance, which makes recognition based on image information, such as object recognition, difficult. In addition, a proximity sensor is not allowed to be disassembled and replaced as being embedded in a compliant object, so that maintainability and expandability are low. In addition, an accuracy in proximity sense is greatly influenced by a deterioration or a change in characteristics of the compliant object due to prolonged use.

In contrast to the above, in the sensor device 3 according to the embodiment, the employment of the meshed structure of the compliant material (the gel 10) allows for both a proximity sense function, or object recognition, and distance measurement. In addition, the separation between the compliant material and the imaging system makes replacement easy, so that maintainability and expandability are high. The separation between the compliant material and the imaging system also reduces a direct influence of a deterioration of the compliant material on the imaging system.

It is to be noted that effects described herein are merely by way of example and not of limitation and any other effect are possible. The same applies to effects of other embodiments hereinbelow.

### 2. Other Embodiments

A technique of the present disclosure is not limited to the above description of the embodiment and may be modified in a variety of manners.

For example, the present technology may have the following configuration.

The present technology with the following configuration allows for observation of a flexible layer attached to a sensor structure and observation of an object in the outside world through a hole of the flexible layer by virtue of an imaging device installed in the sensor structure. This makes it possible to perform a highly accurate multimodal sensing.

(1)

A sensor device including:

a flexible layer having at least one hole; and

a sensor structure attached with the flexible layer, the sensor structure including an imaging device, the imaging device being configured to observe the flexible layer and observe an object in an outside world through the hole of the flexible layer.

(2)

The sensor device according to (1), in which

the sensor device has a function as a tactile sensor that acquires tactile information on the basis of deformation information regarding the flexible layer observed via the imaging device and a function as a proximity sensor that acquires proximity information on the basis of observation information regarding the object observed through the hole of the flexible layer.

(3)

The sensor device according to (2), further including

an information processor that acquires, as information regarding a plurality of modals, the tactile information and the proximity information on the basis of sensor information from the imaging device.

(4)

The sensor device according to (2) or (3), in which

the proximity information includes at least one of information regarding object recognition or information regarding a distance to the object.

(5)

The sensor device according to any one of (2) to (4), in which

the tactile information includes:

information regarding an initial slip and a whole slip of the flexible layer relative to the object; and

at least one of information regarding a contact position with the object or information regarding a contact force relative to the object.

(6)

The sensor device according to any one of (1) to (5), including

as the imaging device, at least one color image sensor configured to acquire a color image.

(7)

The sensor device according to (6), further including

as the imaging sensor, at least one distance sensor configured to acquire distance information.

(8)

The sensor device according to any one of (1) to (5), including

as the imaging device, at least one color image sensor configured to acquire a color image and distance information.

(9)

The sensor device according to any one of (1) to (8), in which

the flexible layer has a grid structure or a honeycomb structure, the grid structure or the honeycomb structure having a plurality of the holes.

(10)

The sensor device according to any one of (1) to (9), in which

a front surface of the flexible layer has a curved shape.

(11)

The sensor device according to any one of (1) to (10), in which

a ratio of occupancy of a region other than the hole in the flexible layer is 10% or less.

(12)

The sensor device according to any one of (1) to (11), in which

the flexible layer includes a transparent compliant material.

(13)

The sensor device according to any one of (1) to (12), in which

a front surface of the flexible layer partially has a slit.

(14)

The sensor device according to any one of (1) to (13), in which

a front surface of the flexible layer partially has a protrusion.

(15)

The sensor device according to any one of (1) to (14), in which

a front surface of the flexible layer partially includes a colored part.

(16)

The sensor device according to (15), in which

the colored part includes a plurality of colored parts different in shape or color.

(17)

The sensor device according to any one of (1) to (16), in which

the flexible layer has, as the hole, a plurality of holes, and

the plurality of holes is in respective shapes in which respective directions of the plurality of holes are toward the imaging device as approaching, as the flexible layer being seen in a lateral direction, a bottom surface from a front surface.

(18)

The sensor device according to any one of (1) to (17), in which

the flexible layer and the sensor structure form a whole or a part of a manipulator of a robot as a whole.

(19)

A robot including:

a sensor device; and

a control device that performs a robot control based on sensor information from the sensor device,

in which the sensor device includes:

a flexible layer having at least one hole; and

a sensor structure attached with the flexible layer, the sensor structure including an imaging device, the imaging device being configured to observe the flexible layer and observe an object in an outside world through the hole of the flexible layer.

(20)

The robot according to (19), further including

a manipulator,

in which the sensor device as a whole forms a whole or a part of the manipulator.

The present application claims the benefit of Japanese Priority Patent Application JP2021-214428 filed with the Japan Patent Office on Dec. 28, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A sensor device comprising:
a flexible layer having at least one hole; and
a sensor structure attached with the flexible layer, the sensor structure including an imaging device, the imaging device being configured to observe the flexible layer and observe an object in an outside world through the hole of the flexible layer.

2. The sensor device according to claim 1, wherein
the sensor device has a function as a tactile sensor that acquires tactile information on a basis of deformation information regarding the flexible layer observed via the imaging device and a function as a proximity sensor that acquires proximity information on a basis of observation information regarding the object observed through the hole of the flexible layer.

3. The sensor device according to claim 2, further comprising
an information processor that acquires, as information regarding a plurality of modals, the tactile information and the proximity information on a basis of sensor information from the imaging device.

4. The sensor device according to claim 2, wherein
the proximity information includes at least one of information regarding object recognition or information regarding a distance to the object.

5. The sensor device according to claim 2, wherein
the tactile information includes:
information regarding an initial slip and a whole slip of the flexible layer relative to the object; and
at least one of information regarding a contact position with the object or information regarding a contact force relative to the object.

6. The sensor device according to claim 1, comprising
as the imaging device, at least one color image sensor configured to acquire a color image.

7. The sensor device according to claim 6, further comprising
as the imaging sensor, at least one distance sensor configured to acquire distance information.

8. The sensor device according to claim 1, comprising
as the imaging device, at least one color image sensor configured to acquire a color image and distance information.

9. The sensor device according to claim 1, wherein
the flexible layer has a grid structure or a honeycomb structure, the grid structure or the honeycomb structure having a plurality of the holes.

10. The sensor device according to claim 1, wherein
a front surface of the flexible layer has a curved shape.

11. The sensor device according to claim 1, wherein
a ratio of occupancy of a region other than the hole in the flexible layer is 10% or less.

12. The sensor device according to claim 1, wherein
the flexible layer includes a transparent compliant material.

13. The sensor device according to claim 1, wherein
a front surface of the flexible layer partially has a slit.

14. The sensor device according to claim 1, wherein
a front surface of the flexible layer partially has a protrusion.

15. The sensor device according to claim 1, wherein
a front surface of the flexible layer partially includes a colored part.

16. The sensor device according to claim 15, wherein
the colored part includes a plurality of colored parts different in shape or color.

17. The sensor device according to claim 1, wherein
the flexible layer has, as the hole, a plurality of holes, and
the plurality of holes is in respective shapes in which respective directions of the plurality of holes are toward the imaging device as approaching, as the flexible layer being seen in a lateral direction, a bottom surface from a front surface.

18. The sensor device according to claim 1, wherein
the flexible layer and the sensor structure form a whole or a part of a manipulator of a robot as a whole.

19. A robot comprising:
a sensor device; and
a control device that performs a robot control based on sensor information from the sensor device,
wherein the sensor device includes:
a flexible layer having at least one hole; and
a sensor structure attached with the flexible layer, the sensor structure including an imaging device, the imaging device being configured to observe the flexible layer and observe an object in an outside world through the hole of the flexible layer.

20. The robot according to claim 19, further comprising
a manipulator,
wherein the sensor device as a whole forms a whole or a part of the manipulator.
